(19) United States
(12) Patent Application Publication
(10) Pub. No.: US 2026/0205993 A1
(43) Pub. Date: Jul. 16, 2026

(54) METHOD AND APPARATUS FOR CONFIGURING SOUNDING REFERENCE SIGNAL TRANSMISSION FOR ESTIMATING LOCATION OF INACTIVE TERMINAL IN WIRELESS COMMUNICATION SYSTEM

(71) Applicant: Samsung Electronics Co., Ltd., Gyeonggi-do (KR)

(72) Inventors: Taeseop LEE, Gyeonggi-do (KR); Beomsik BAE, Gyeonggi-do (KR); Seungri JIN, Gyeonggi-do (KR)

(21) Appl. No.: 19/443,520

(22) Filed: Jan. 8, 2026

(30) Foreign Application Priority Data
Jan. 10, 2025 (KR) 10-2025-0004286
Apr. 25, 2025 (KR) 10-2025-0054515

(51) Int. Cl. H04W 64/00; H04L 5/00

(52) U.S. Cl. CPC H04W 64/00; H04L 5/0048

(57) ABSTRACT

The disclosure relates to a 5G or 6G communication system for supporting a higher data transmission rate. A method performed by a first base station includes receiving, from a second base station, a retrieve user equipment (UE) context request message; transmitting, to a location management function (LMF), a positioning information update message including sounding reference signal (SRS) transmission status information, wherein the SRS transmission status information is set to an area-specific SRS activated; receiving, from the LMF, a positioning activation request message for activating a semi-persistent SRS resource set based on the SRS transmission status information; and transmitting, to the second base station, a message including information on the semi-persistent SRS resource set, as a response to the retrieve UE context request message being provided.

### CROSS-REFERENCE TO RELATED APPLICATION(S)

The present application is based on and claims priority to Korean Patent Application Nos. 10-2025-0004286 and 10-2025-0054515, filed in the Korean Intellectual Property Office on Jan. 10, 2025, and Apr. 25, 2025, respectively, the entire content of each of which is incorporated herein by reference.

### BACKGROUND

### 1. Field

The disclosure relates generally to a wireless communication system, and more particularly, to a method and an apparatus for providing a location estimation service in a wireless communication system.

### 2. Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as millimeter wave (mmWave) including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### SUMMARY

An aspect of the disclosure is to provide a method of more efficiently configuring and transmitting an SRS by defining various SRS transmission configuration procedures when the location of a UE in an inactive state is estimated in a mobile communication system.

An aspect of the disclosure is to provide a method and apparatus to minimize power consumption of the UE, maximize the utilization of network resources, and guarantee more accurate estimation of the location of the UE by defining various SRS transmission configuration procedures.

In accordance with an aspect of the disclosure, a method performed by a first base station, the method comprising: receiving, from a second base station, a retrieve user equipment (UE) context request message; transmitting, to a location management function (LMF), a positioning information update message including sounding reference signal (SRS) transmission status information, wherein the SRS transmission status information is set to an area-specific SRS activated; receiving, from the LMF, a positioning activation request message for activating a semi-persistent SRS resource set based on the SRS transmission status information; and transmitting, to the second base station, a message including information on the semi-persistent SRS resource set, as a response to the retrieve UE context request message is provided.

In accordance with another aspect of the disclosure, a method performed by a second base station, the method comprising: transmitting, to a first base station, a retrieve user equipment (UE) context request message; receiving, from the first base station, a message including information on a semi-persistent sounding reference signal (SRS) resource set, as a response to the retrieve UE context request message; and transmitting, to the UE, a medium access control (MAC) control element (CE) for activating the semi-persistent SRS resource set, wherein the information on the semi-persistent SRS resource set is based on a positioning activation request message transmitted for activating the semi-persistent SRS resource set based on SRS transmission status information, and wherein the SRS transmission status information is set to an area-specific SRS activated is provided.

In accordance with another aspect of the disclosure, a first base station comprising: at least one transceiver; at least one processor communicatively coupled to the at least one transceiver; and at least one memory, communicatively coupled to the at least one processor, storing instructions executable by the at least one processor individually or in any combination to cause the first base station to: receive, from a second base station, a retrieve user equipment (UE) context request message, transmit, to a location management function (LMF), a positioning information update message including sounding reference signal (SRS) transmission status information, wherein the SRS transmission status information is set to an area-specific SRS activated, receive, from the LMF, a positioning activation request message for activating a semi-persistent SRS resource set based on the SRS transmission status information, and transmit, to the second base station, a message including information on the semi-persistent SRS resource set, as a response to the retrieve UE context request message is provided.

In accordance with another aspect of the disclosure, a second base station comprising: at least one transceiver; at least one processor communicatively coupled to the at least one transceiver; and at least one memory, communicatively coupled to the at least one processor, storing instructions executable by the at least one processor individually or in any combination to cause the second base station to: transmit, to a first base station, a retrieve user equipment (UE) context request message; receive, from the first base station, a message including information on a semi-persistent sounding reference signal (SRS) resource set, as a response to the retrieve UE context request message, and transmit, to the UE, a medium access control (MAC) control element (CE) for activating the semi-persistent SRS resource set, wherein the information on the semi-persistent SRS resource set is based on a positioning activation request message transmitted for activating the semi-persistent SRS resource set based on SRS transmission status information, and wherein the SRS transmission status information is set to an area-specific SRS activated is provided.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates the structure of a next-generation mobile communication system according to an embodiment;

FIG. 2 illustrates the structure of a network for providing a UE location estimation service in the next-generation mobile communication system according to an embodiment;

FIG. 3 illustrates a detailed message exchange process between configurations of the network for configuring SRS resources of the UE in the operation of an uplink (UL) positioning method and a downlink (DL)+UL positioning method according to an embodiment;

FIG. 4 illustrates a process in which the UE receives SRS transmission configuration information while transitioning to a radio resource control (RRC)_INACTIVE state and then moves to another cell range, so the SRS transmission configuration is released, according to an embodiment;

FIG. 5 illustrates a process in which the UE activates SRS transmission in the RRC_INACTIVE state according to an embodiment;

FIG. 6 illustrates a process in which even though the UE receives valid SRS transmission configuration information within a specific range while transitioning to the RRC_INACTIVE state and then moves to another cell range, the SRS transmission configuration is maintained according to an embodiment;

FIG. 7A illustrates a procedure in which the UE receives valid SRS transmission configuration information within a specific range from the base station (BS) and activates SRS transmission in the RRC_INACTIVE state according to an embodiment;

FIG. 7B illustrates a procedure in which the UE receives valid SRS transmission configuration information within a specific range from the BS and activates SRS transmission in the RRC_INACTIVE state according to an embodiment;

FIG. 8 illustrates a procedure in which a gNB prepares valid SRS transmission configuration information within a specific range according to an embodiment;

FIG. 9 illustrates the structure of the UE according to an embodiment; and

FIG. 10 illustrates the structure of the BS according to an embodiment.

### DETAILED DESCRIPTION

Hereinafter, embodiments of the disclosure are described with reference to the accompanying drawings. Accordingly, those of ordinary skill in the art will recognize that various changes and modifications of the embodiments described herein can be made without departing from the scope and spirit of the present disclosure. Descriptions of well-known functions and constructions may be omitted for the sake of clarity and conciseness.

In the drawings, some elements are exaggerated, omitted, or only briefly outlined, and the size of each element does not necessarily reflect the actual size. The same or similar reference symbols are used throughout the drawings to refer to the same or like parts.

Advantages and features of the disclosure and methods for achieving them will be apparent from the following detailed description of embodiments taken in conjunction with the accompanying drawings. However, the disclosure is not limited to the embodiments disclosed below but may be implemented in various manners. The embodiments are provided only to complete the disclosure and to fully inform the scope of the disclosure to those skilled in the art to which the disclosure pertains.

Some components are exaggerated, omitted, or schematically illustrated in the accompanying drawings. The size of each component does not totally reflect the actual size. In each figure, the same reference numeral is assigned to the same or corresponding component.

Advantages and features of the disclosure and methods of achieving the same will become clear with reference to the accompanying drawings and embodiments described below in detail. However, the disclosure is not limited to the following embodiments and may be implemented in various different forms, and the embodiments are provided to fully inform those skilled in the art of the scope of the disclosure.

The term “unit (or ~er)” used in the embodiments refers to a software or hardware component such as a Field-Programmable Gate Array (FPGA) or an Application Specific Integrated Circuit (ASIC), and the “unit (or ~er)” may play some roles. However, the “unit (or ~er)” is not limited to software or hardware. The “unit (or ~er)” may be configured to be in an addressable storage medium or configured to reproduce one or more processors. Accordingly, for example, the “unit (or ~er)” includes software components, object-oriented software components, components such as class components and task components, processes, functions, attributes, procedures, subroutines, segments of program code, drivers, firmware, microcode, a circuit, data, a database, data structures, tables, arrays, and parameters. Functions provided within components and “units (or ~ers)” may be combined with the smaller number of components and “units (or ~ers)” or more separated into additional components and “units (or ~ers)”. In addition, the components and the “units (or ~ers)” may be implemented to reproduce one or more CPUs within a device or a secure multimedia card. In embodiments, the “unit (or ~er)” may include one or more processors.

Terms for identifying access nodes and referring to network entities, messages, interfaces between network entities, terms referring to various pieces of identification information, and the like are used for convenience of description. Accordingly, the disclosure is not limited to terms described below, and other terms referring to a target having the equivalent technical meaning may be used.

Hereinafter, the disclosure uses terms and names defined in a 3rd generation partnership project long term evolution (3GPP LTE) standard. However, the disclosure is not limited to the terms and names and may be equally applied to systems following other standards. In the disclosure, an eNB may be interchangeably used with a gNB for convenience of description. That is, a BS described as an eNB may be a gNB.

Hereinafter, the BS is the entity that allocates resources to a terminal and may be at least one of a gNode B, an eNode B, a Node B, a radio access unit, a BS controller, or a node on a network. The terminal may include a UE, a mobile station (MS), a cellular phone, a smartphone, a computer, or a multimedia system capable of performing a communication function. The disclosure is not limited to the above example.

The LTE, LTE-A, LTE Pro, or 5G (or NR, next-generation mobile communication) system is described herein, but the embodiments of the disclosure may be applied to other communication systems having the similar technical background or channel form. Embodiments of the disclosure may be applied to other communication systems through some modifications without departing from the scope of the disclosure, based on determination by those skilled in the art.

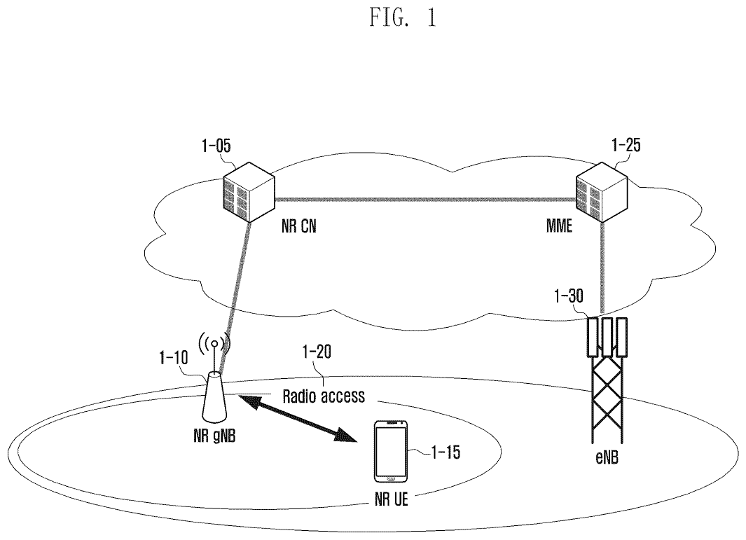

FIG. 1 illustrates the structure of a next-generation mobile communication system according to an embodiment.

Referring to FIG. 1, a radio access network of the next-generation mobile communication system (hereinafter, NR or 2g) may include a next-generation BS (new radio node B, hereinafter, an NR NB, a gNB, an NR gNB, or an NR BS) 1-10 and a new radio core network (NR CN) 1-05. The disclosure is not limited to the above example, and the radio access network of the next-generation mobile communication system may include more entities. An NR UE or a terminal) 1-15 may access an external network through the NR gNB 1-10 and/or the NR CN 1-05.

In FIG. 1, the NR gNB 1-10 may correspond to an eNB in the conventional LTE system. The NR gNB 1-10 may be connected to the NR UE 1-15 through a radio channel 1-20 and may provide better service than a conventional node B. Since all user traffic is served through a shared channel in the next-generation mobile communication system, a device for collecting and scheduling state information such as buffer states, available transmission power states, and channel states of UEs is required, which may be performed by the NR gNB 1-10. One NR gNB 1-10 may control a plurality of cells.

According to an embodiment, the next-generation mobile communication system may have a bandwidth wider than the conventional maximum bandwidth to implement super-high-speed data transmission compared to the LTE system and may provide additional beamforming technology through orthogonal frequency division multiplexing (OFDM) as radio access technology. The next-generation mobile communication system may use an adaptive modulation and coding (AMC) scheme of determining a modulation scheme and a channel coding rate in correspondence to a channel state of the UE. The NR CN 1-05 may perform a function of supporting mobility, configuring a bearer, configuring quality of service (QoS), and the like. The NR CN 1-05 controls various control functions as well as a function of managing mobility of the UE and may be connected to a plurality of BSs. The next-generation mobile communication system may be linked to the conventional LTE system, and the NR CN 1-05 may be connected to a mobility management entity (MME) 1-25 through a network interface. The MME may be connected to the eNB 1-30 which is a BS of an LTE system.

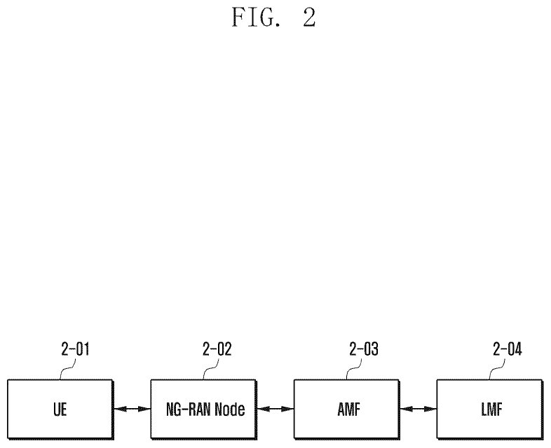

FIG. 2 illustrates the structure of a network for providing a UE location estimation service in the next-generation mobile communication system according to an embodiment.

Referring to FIG. 2, in the next-generation mobile communication system, a network for providing a UE location services (LCS)) may include a UE 2-01, an NG-RAN node 2-02, an access and mobility function (AMF) 2-03, and/or a location management function (LMF) 2-04. The UE 2-01 may communicate with the LMF 2-04 through the NG-RAN node 2-02 and/or the AMF 2-03 and exchange information required for location estimation. Although FIG. 2 illustrates an example in which the single UE 2-01 interact with other components of the network for providing the LCS for convenience of description, the network for providing the LCS may include a plurality of UEs (or a plurality of target UEs). The role of each component for providing the LCS may be described below.

The UE 2-01 may measure a radio signal required for location estimation and transfer the result to the LMF 2-04.

The NG-RAN node 2-02 may transmit a DL radio signal required for location estimation to the UE 2-01 and measure a UL radio signal transmitted by the target UE 2-01, and the like.

The AMF 2-03 may receive an LCS request message from an LCS requester and then transfer the same to the LMF 2-04, to indicate provision of the LCS. When the LMF 2-04 processes the request for location estimation and then respond to the AMF 2-03 with the location estimation result of the UE 2-01, the AMF 2-03 may transfer the result to the LCS requester.

The LMF 2-04 may receive the LCS request from the AMF 2-03 and estimate the location of the UE 2-01 for the LCS, and may control overall processes required for estimating the location of the UE 2-01. To estimate the location of the UE 2-01, the LMF 2-04 may provide auxiliary information required for location estimation and/or signal measurement to the UE 2-01 and receive a result value from the UE 2-01. An LTE positioning protocol (LPP) may be used as a protocol for data exchange between the UE 2-01 and the LMF 2-04. The LPP may define the message specification exchanged between the UE 2-01 and the LMF 2-04 for the location estimation service. The LMF 2-04 may exchange configuration information of a DL positioning reference signal (PRS) to be used for location estimation and/or the measurement result of a UL sounding reference signal (SRS) received from the UE 2-01. An NR positioning protocol A (NRPPa) may be used as a protocol for data exchange between the LMF 2-04 and the NG RAN node 2-02. The NRPPa may define the message specification exchanged between the NG RAN node 2-02 and the LMF 2-04.

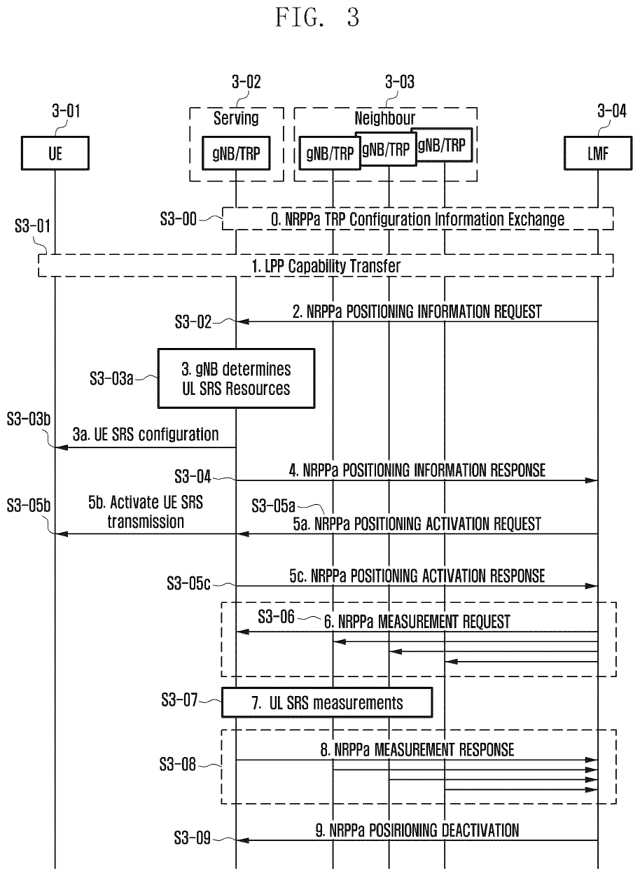

FIG. 3 illustrates a detailed message exchange process between configurations of the network for configuring SRS resources of the UE in the operation of a UL positioning method and a DL+UL positioning method according to an embodiment.

Referring to FIG. 3, to perform the operation of the UL positioning method and/or the DL+UL positioning method, an LMF 3-04 may configure an SRS required for a UE 3-01. The UL positioning method may be UL-time difference of arrival (UL-TDOA) or UL-angle of arrival (UL-AOA) as an example, and the DL+UL positioning method may be multi-round trip time (multi-RTT) as an example. A detailed operation of the network in which the LMF 3-04 configures the SRS required for the UE 3-01 is described in detail through FIG. 3.

All the steps illustrated in FIG. 3 do not have to be included according to configurations and/or definition of the system, or the like, and some steps may be omitted.

In step 300, the LMF 3-04 may acquire NRPPa TRP configuration information required for performing the UL positioning method from a serving gNB/TRP 3-02 and/or a neighbor gNB/TRP 3-03. The NRPPa TRP configuration information may include at least one of NR cell information, PRS configuration, spatial direction information, or location information.

In step 301, the LMF 3-04 may make a request for capability information of the UE 3-01 related to location estimation to the UE 3-01 and receive the capability information in response thereto from the UE 3-01.

In step 302, the LMF 3-04 may transmit an NRPPa POSITIONING INFORMATION REQUEST message to the serving gNB 3-02 to make a request for configuring SRS transmission resources of the UE 3-01 required for UL positioning, based on pre-collected information. The NRPPa POSITIONING INFORMATION REQUEST message may include at least one of the number of required SRS resources, periodicity, pathloss reference, or spatial relation information. The information pre-collected by the LMF 3-04 may include at least one of location information of neighbor TRPs 3-03, the existing location information of the UE 3-01, SSB and/or PRS transmission information of TRPs 3-02 and 3-03.

In step 303a, the serving gNB 3-02 may receive the NRPPa POSITIONING INFORMATION REQUEST message transmitted according to step 302 from the LMF 3-04 and then finally determine the SRS resource configuration for the UE 3-01, based on the message content.

In step 303b, the serving gNB 3-02 may transfer the SRS resource configuration determined in step 303a to the UE 3-01 through RRC signaling (for example, an RRCReconfiguration message).

In step 304, the serving gNB 3-02 may transfer information on the SRS resource configuration determined in step 303a to the LMF 3-04 through an NRPPa POSITIONING INFORMATION RESPONSE message. The information on the SRS resource configuration may include the location of SRS resources in the time/frequency axis, periodicity, spatial relation information, or the like.

In step 305a, when the LMF 3-04 identifies that a semi-persistent or aperiodic type SRS resource set is configured based on the NRPPa POSITIONING INFORMATION RESPONSE message transmitted according to step 304, the LMF 3-04 may transmit an NRPPa POSITIONING ACTIVATION REQUEST message for making a request for activating SRS transmission of the UE 3-01 to the serving gNB 3-02.

In step 305b, when the serving gNB 3-02 receives the NRPPa message from the LMF 3-04 according to step 305a, the serving gNB 3-02 may indicate SRS transmission activation to the UE 3-01 through MAC CE or DCI.

In step 305c, in response to step 305a, the serving gNB 3-02 may transmit an NRPPa POSITIONING ACTIVATION RESPONSE message to inform the LMF 3-04 of whether the SRS transmission activation has been completed.

In step 306, the LMF 3-04 may transmit an NRPPa MEASUREMENT REQUEST message to the serving gNB/TRP 3-02 and/or the neighbor gNB/TRP 3-03 to make a request for measuring the SRS transmitted by the UE 3-01 and/or reporting the result. The NRPPa message may include SRS resource information configured in the UE 3-01.

In step 307, depending on the MEASUREMENT REQUEST NRPPa message according to step 306, the serving gNB/TRP 3-02 and/or the neighbor gNB TRP 3-03 receiving the request for SRS measurement from the LMF 3-04 may measure SRS transmitted by the UE 3-01, based on SRS configuration information included in the NRPPa MEASUREMENT REQUEST message according to step 306.

In step 308, the serving gNB/TRP 3-02 and/or the neighbor gNB/TRP 3-03 measuring the SRS in step 307 may transfer the measurement result to the LMF 3-04 through an NRPPa MEASUREMENT RESPONSE message.

In step 309, after finishing the above-described location estimation scheme operation, the LMF 3-04 may transmit an NRPPa POSITIONING DEACTIVATION message to the serving gNB 3-02 to deactivate SRS transmission requested in step 305a.

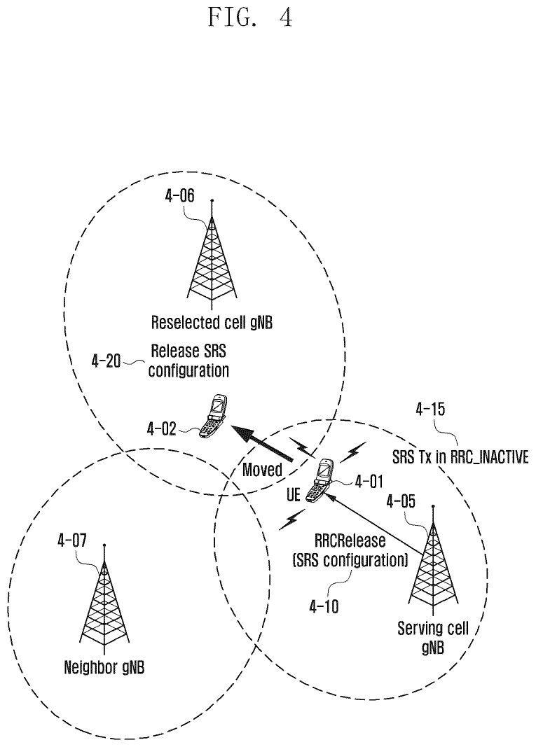

FIG. 4 illustrates a process in which the UE receives SRS transmission configuration information while transitioning to an RRC_INACTIVE state and then moves to another cell range, so the SRS transmission configuration is released according to an embodiment.

Referring to FIG. 4, a gNB 4-05 may indicate SRS transmission to estimate the location of the UE 4-01 while transitioning the UE 4-01 to the RRC_INACTIVE state through transmission of an RRCRelease message 4-10. To transition the UE 4-01 to the RRC_INACTIVE state and indicate SRS transmission, the RRCRelease message 4-10 may be included in SRS transmission configuration information (e.g., SRS-PosRRC-Inactive) to be used in the RRC_INACTIVE state. The SRS transmission configuration information may include at least one of the SRS transmission resource configuration (for example, SRS-PosConfig) or the BWP configuration to transmit the SRS. The UE 4-01 receiving the RRCRelease message 4-10 including the SRS transmission configuration information may perform SRS transmission 4-15, based on the configured information, even in the RRC_INACTIVE state. The SRS transmission configuration information may include one or more of SRS resource sets (for example, SRS-PosResourceSet) constituted by a plurality of SRS resources (for example, SRS-PosResource). The type of the SRS resource set may be configured as “periodic” or “semi-persistent”.

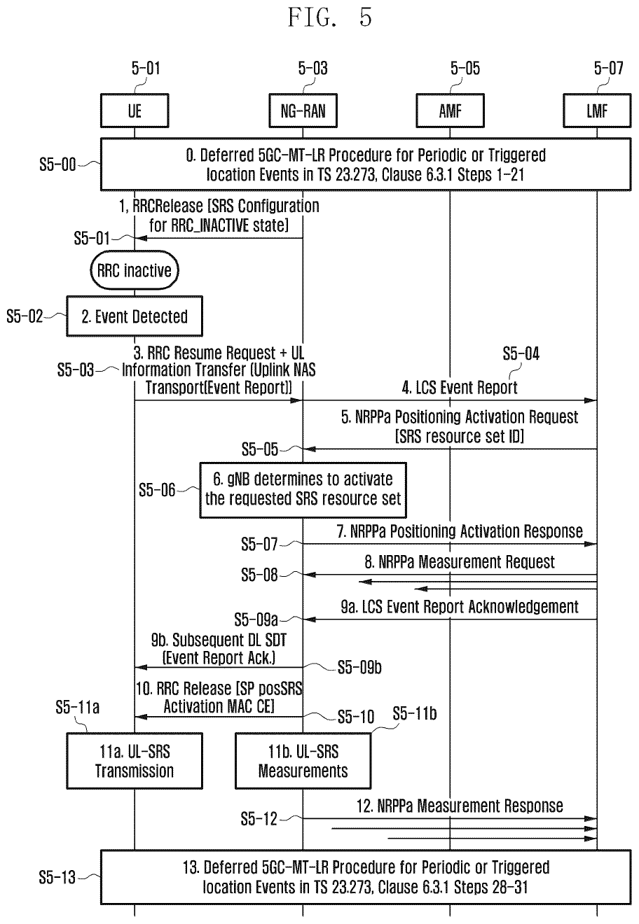

When the “periodic” type SRS resource set is included in the SRS transmission configuration, the UE 4-01 may start periodic SRS transmission by using SRS resources constituting the SRS resource set without a separate activation procedure after receiving the RRCRelease. In contrast, when the “semi-persistent” type SRS resource set is included in the SRS transmission configuration, the gNB 4-05 may activate the SRS resource set through additional medium access control (MAC) control element (CE) (e.g., SP positioning SRS activation/deactivation MAC CE) transmission and then the UE 4-01 may start SRS transmission by using SRS resources constituting the SRS resource set. The procedure of instructing the UE in the RRC_INACTIVE state to active transmission of the “semi-persistent” type SRS resource set is described below with reference to FIG. 5.

When the UE 4-01 performs SRS transmission in the RRC_INACTIVE state, it is possible to reduce power consumption of the UE 4-01 for location estimation as only SRS transmission can be performed without any operation (for example, physical DL control channel (PDCCH) monitoring, beam management operation, channel estimation operation, or the like) which the UE 4-01 should perform in an RRC_CONNECTED state. The serving cell gNB 4-05 and/or neighbor gNBs 4-06 and 4-07 may estimate the location of the UE 4-01, based on a scheme in which the serving cell gNB 4-05 and/or the neighbor gNBs 4-06 and 4-07 receive the SRS transmitted by the UE 4-01 and then transfer the result to the LMF.

However, when a reselection condition to another cell is satisfied according to movement of the UE 4-01 in the RRC_INACTIVE state, the UE 4-01 may reselect a new cell. When the UE 4-01 reselects another cell, which is not the serving cell having configured SRS configuration information in the RRC_INACTIVE state through the RRCRelease message, the UE 4-01 may stop SRS transmission and release the SRS configuration received from the serving cell gNB 4-05 as indicated by reference numeral 4-20. When the UE 4-01 stops SRS transmission in the RRC_INACTIVE state, the gNBs 4-05, 4-06, and 4-07 measuring the SRS transmitted by the UE 4-01 for location estimation may fail in measuring the SRS. Thereafter, the network may re-attempt to configure SRS transmission for estimating the location of the UE 4-01, and the UE 4-01 may receive SRS transmission configuration information again only when the UE 4-01 transitions to the RRC_CONNECTED state. The transition of the UE 4-01 to the RRC_CONNECTED state may be a major factor in increasing power consumption of the UE 4-01 during the location estimation process.

FIG. 5 illustrates a process in which the UE activates SRS transmission in the RRC_INACTIVE state according to an embodiment.

Referring to FIG. 5, when an event that requires SRS transmission in the RRC_INACTIVE state is generated, a UE 5-01 may report the above event to an LMF 5-07. Thereafter, the UE 5-01 may receive an indication of SRS transmission activation and perform SRS transmission.

All the steps illustrated in FIG. 5 do not have to be included according to configurations and/or definition of the system, or the like, and some steps may be omitted.

In step 500, the UE 5-01 may receive a configuration of the event which requires SRS transmission from the network. For example, related steps in the relevant standard may be performed for a deferred 5GC-mobile terminated location request (5GC-MT-LR) procedure for the periodic or triggered location event specified in the relevant standard (e.g. TS23.273 Clause 6.3.1). The LMF 5-07 may perform one or more positioning procedures in the relevant standard and make a request for or acquire UE positioning capability or provide required support data to a target device. LCS periodic-triggered location invoked in the relevant standard may be included in an embedded LPP request location information message indicating location measurement and/or SRS transmission allowed or required for each reported location event. The UE 5-01 may transition from RRC_CONNECTED to RRC_INACTIVE through RRCRelease including SuspendConfig transmitted by the last serving gNB.

In step 501, an NG-RAN 5-03 may transmit an RRC release message including SRS configuration information applied in the RRC_INACTIVE state to the UE 5-01. For example, the NG-RAN 5-03 may transmit the RRC release message including suspendConfig to the UE 5-01 and transition the UE 5-01 to the RRC_INACTIVE state. The RRC release message may also include SRS transmission configuration information (for example, SRS-PosRRC-Inactive) to be applied to the UE in the RRC_INACTIVE state. The SRS transmission configuration information may include one or more SRS resource sets (for example, SRS-PosResourceSet) constituted by a plurality of SRS resources (for example, SRS-PosResource). The type of the SRS resource set may be configured as “periodic” or “semi-persistent”. When the “periodic” type SRS resource set is included in the SRS transmission configuration, the UE 5-01 may start periodic SRS transmission by using SRS resources constituting the SRS resource set without a separate activation procedure after receiving the RRCRelease.

In contrast, when the “semi-persistent” type SRS resource set is included in the SRS transmission configuration, the NG-RAN 5-03 may activate the SRS resource set through additional MAC CE (for example, SP positioning SRS activation/deactivation MAC CE) transmission and then the UE 5-01 may start SRS transmission by using SRS resources constituting the SRS resource set. The flowchart of FIG. 5 may be based on the assumption that only the “semi-persistent” type SRS resource set is configured in the UE 5-01 in the RRC_INACTIVE state. Accordingly, when an event that requires SRS transmission is generated as in step 502 below, a procedure for instructing the UE 5-01 to active transmission of the “semi-persistent” type SRS resource set may be performed.

In step 502, the UE 5-01 may monitor and detect the generation of the trigger or periodic event requested in step 500. When the UE 5-01 detects the generation of the requested event, the UE 5-01 may start a procedure for reporting the same to the LMF 5-07.

In step 503, the UE 5-01 may transmit a UL information transfer message including UL NAS transport to the NG-RAN 5-03 along with an RRC resume request message. The UL NAS transport may include report information for the event generated in step 502. For example, when the event is detected (or right before the event is detected), the UE 5-01 may transmit an RRC UL information transfer message including the UL NAS transport message to the NG-RAN 5-03 along with the RRC resume request using small data transmission (SDT). The UE 5-01 may include an LCS event report in a payload container of the UL NAS transport message. The NG-RAN 5-03 receiving the message in step 503 may be the same as or different from the last serving gNB when the UE 5-01 transitions to the RRC_INACTIVE state.

In step 504, the NG-RAN 5-03 may transmit an LCS event report message to the LMF 5-07. For example, the NG-RAN (receiving gNB) receiving the message in step 503 may transmit the LCS event report to a serving AMF 5-05 along with an LPP request assistance data message included in an NGAP UL NAS transport message. The AMF 5-05 may determine the LMF 5-07 from a deferred routing identifier (ID) received by an additional information element (IE) of the UL NAS transport message. The AMF 5-05 may trigger a Namf_Communication_N1MessageNotify service operation and transfer the LCS event report to the LMF 5-07 along with the embedded LPP message.

When an anchor BS is unchanged from the last serving gNB to the receiving gNB, the LCS event report may be transferred from the receiving gNB to the last serving gNB through RRC TRANSFER corresponding to an XnAP message as in the relevant standard. The following DL/UL message may also be transferred from the last serving gNB to the receiving gNB through RRC TRANSFER corresponding to the XnAP message.

In step 505, the LMF 5-07 may transmit an NRPPa positioning activation request message to the NG-RAN 5-03. For example, based on information within the LCS event report received in step 504, the LMF 5-07 may determine that the UE 5-01 should perform SRS transmission for UL/DL+UL location estimation in the RRC_INACTIVE state. When one or more “semi-persistent” type SRS resource sets are configured in the UE 5-01 in step 501, the LMF 5-07 may transmit the NRPPa positioning activation request message to the NG-RAN 5-03 to make a request for activating transmission of one of the SRS resource sets. The NRPPa positioning activation request message may include at least one piece of information on an ID value for indicating the SRS resource set to be activated, transmission beam configuration information to be used for transmission for each SRS resource constituting the SRS resource set (spatial relation information per SRS resource), or a transmission activation time point. Although omitted in FIG. 5, the NG-RAN 5-03 may also provide the LMF 5-07 with SRS configuration information applied in the RRC_INACTIVE state provided to the UE 5-01 through the RRCRelease message in step 501. Accordingly, the LMF 5-07 may detect SRS configuration information provided to the UE 5-01 through the RRCRelease message according to step 501 before step 505.

In step 506, according to a request from the LMF 5-07 in step 505, the NG-RAN 5-03 may determine whether to activate transmission of one of the “semi-persistent” type SRS resource sets” configured in the UE 5-01 through the RRCRelease message in step 501.

In step 507, the NG-RAN 5-03 may transmit an NRPPa positioning activation response message to the LMF 5-07. For example, the NG-RAN 5-03 may report that transmission activation has been indicated to the UE or will be activated to the LMF 5-07 for the SRS resource set of which activation has been requested by the LMF 5-07 in step 505 through the NRPPa positioning activation response message. For the SRS resource set, information indicating a time point at which actual transmission is activated or will be activated (system frame number and/or slot number) may also be included in the NRPPa message.

In step 508, the LMF 5-07 may transmit an NRPPa measurement request message to the NG-RAN 5-03. For example, the LMF 5-07 may transmit the NRPPa measurement request message including configuration information required for measuring the SRS transmitted by the UE 5-01 to a plurality of NG-RANs. The plurality of NG-RANs may be BSs which should receive the SRS to estimate the location of the UE 5-01.

In step 509a, the LMF 5-07 may transmit an LCS event report acknowledgement (ACK) to the NG-RAN 5-03.

In step 509b, the NG-RAN 5-03 may transmit subsequent DL SDT including the event report ACK to the UE 5-01. For example, when the LMF 5-07 transmits an SS LCS event report ACK to the receiving NG-RAN, the receiving NG-RAN may provide an SS event report ACK to the UE 5-01 through the subsequent DL SDT.

In step 510, the NG-RAN 5-03 may transmit an RRC release message to the UE 5-01. For example, the NG-RAN 5-03 may transmit the RRC Release message including suspendConfig to the UE 5-01, to maintain the UE 5-01 in the RRC_INACTIVE state. The NG-RAN 5-03 may transmit a MAC CE (for example, SP positioning SRS activation/deactivation MAC CE) for instructing the UE 5-01 to activate transmission of the SRS resource set determined to be activated according to a request from the LMF 5-07 to the UE 5-01 along with the RRCRelease message in step 506. The MAC CE may include at least one piece of information on an ID value for indicating the SRS resource set to be activated or deactivated, an ID of a BWP in which the SRS resource set is configured, or transmission beam configuration information to be used for transmission per SRS resource constituting the SRS resource set (spatial relation information per SRS resource).

In step 511a, the UE 5-01 may activate transmission of the “semi-persistent” type SRS resource set in the RRC_INACTIVE state and transmit the SRS. The NG-RAN 5-03 and/or a plurality of neighboring NG-RANs (or TRPs) may receive the SRS transmitted by the UE 5-01.

In step 511b, the NG-RAN/TRP 5-03 may measure the SRS transmitted by the UE 5-01.

In step 512, the NG-RAN 5-03 may transmit an NRPPa measurement response message to the LMF 5-07. For example, NG-RAN(s) receiving the message according to step 508 after the NG-RAN 5-03 performs the UL-SRS measurement may provide the LMF 5-07 with the UL measurement result through the NRPPa measurement response message.

In step 513, the remaining operations for the deferred 5GC-MT-LR procedure may be performed. For example, steps 28 to 31 for the deferred 5GC-MT-LR procedure for the periodic or triggered location event specified in the relevant standard may be performed.

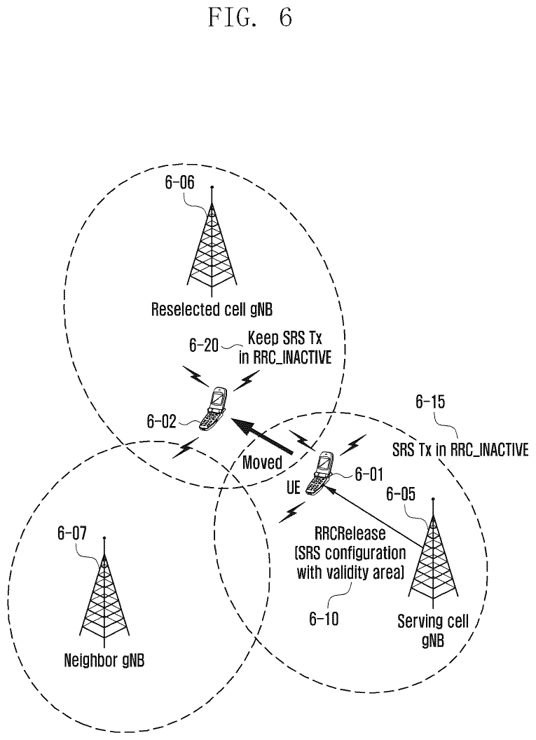

FIG. 6 illustrates a process in which even though the UE receives valid SRS transmission configuration information within a specific range while transitioning to the RRC_INACTIVE state and then moves to another cell range, the SRS transmission configuration is maintained according to an embodiment.

Referring to FIG. 6, a gNB 6-05 may indicate SRS transmission to estimate the location of a UE while transitioning the UE 6-01 to the RRC_INACTIVE state through transmission of an RRCRelease message 6-10. To transition the UE 6-01 to the RRC_INACTIVE state and indicate SRS transmission, the gNB 6-05 may include SRS transmission configuration information (for example, SRS-PosRRC-Inactive and/or srs-PosRRC-InactiveEnhanced) to be used in the RRC_INACTIVE state in the RRCRelease message 6-10. The gNB 6-05 may include a plurality of SRS transmission configurations (for example, SRS-PosRRC-InactiveValidityAreaConfig) in the RRCRelease message. Each SRS transmission configuration may include one or more SRS resource set (SRS-PosResourceSet) constituted by a plurality of SRS resources (SRS-PosResource). Each SRS transmission configuration may be associated with (connected or related to) an area/range (for example, srs-PosConfigValidityArea) in which the configuration is valid.

A maximum of one of the plurality of SRS transmission configurations may be configured as a “non-preconfigured” type example, a srs-PosRRC-InactiveValidityAreaNonPreConfig-r18 type) activated/applied right after the UE 6-01 receives the RRCRelease message. The SRS transmission configuration configured as the “non-preconfigured” type is associated with (connected or related to) a validity area (srs-PosConfigValidityArea) currently including the serving cell 6-05 of the UE 6-01, and the UE 6-01 may directly activate/apply the configuration after receiving the RRCRelease message including the configuration and perform SRS transmission 6-15.

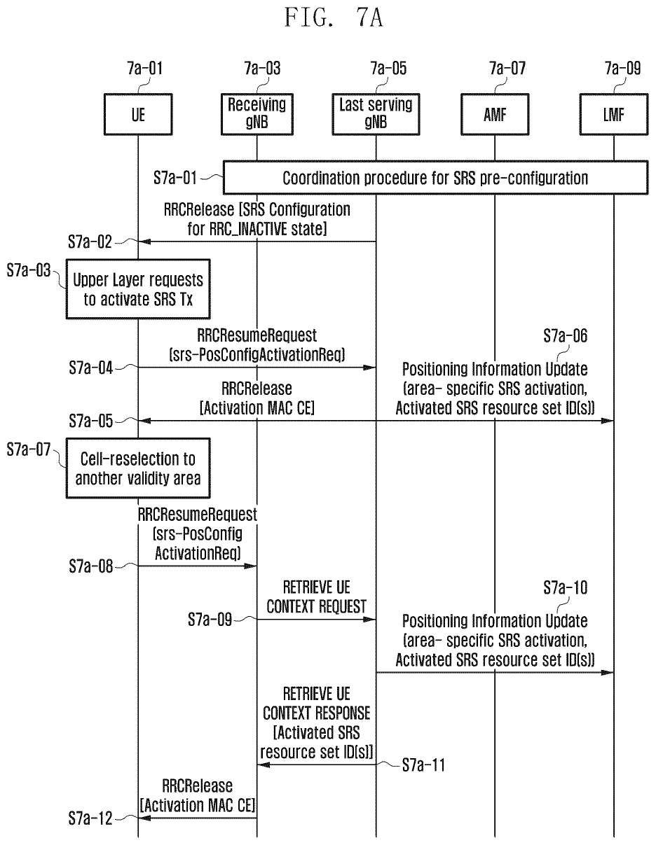

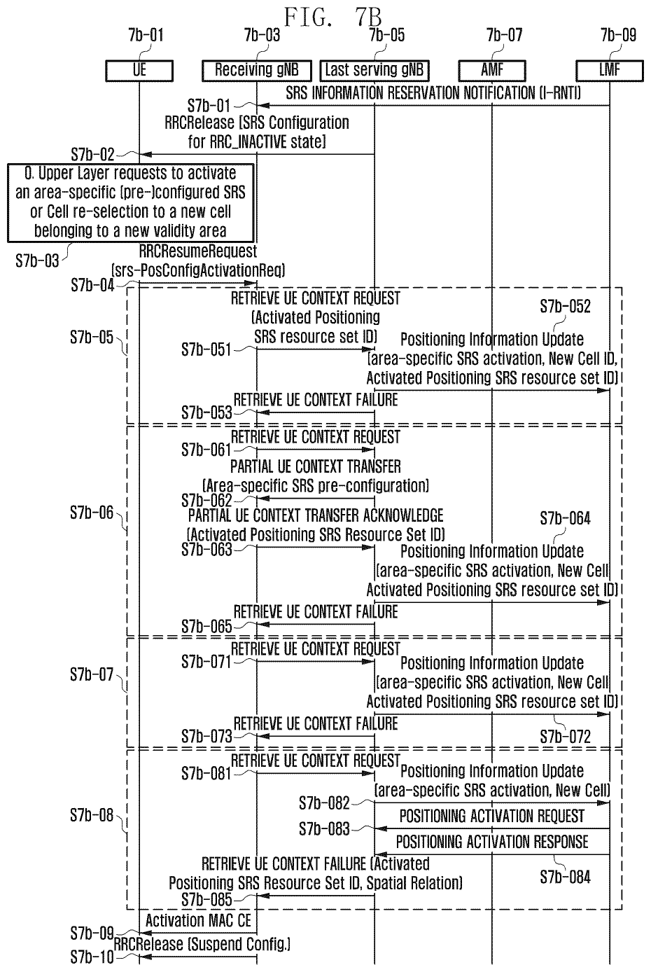

In contrast, configurations connected to a validity area that does not include the serving cell 6-05 of the current UE 6-01 among the plurality of SRS transmission configurations may be configured as the “preconfigured” type (for example, srs-PosRRC-InactiveValidityAreaPreConfigList-r18 type). When a new serving/camped on cell 6-06 is reselected according to movement of the UE 6-01 in the RRC_INACTIVE state, if the cell 6-06 is not included in the validity area associated with (connected or related to) the previously activated SRS transmission configuration but is included in the validity area associated with (connected or related to) another “preconfigured” type SRS transmission configuration, the UE 6-01 may activate/apply the “preconfigured” type SRS transmission configuration connected to the validity area through the RRCResume procedure, as described below with reference to FIG. 7.

In contrast, when a new serving/camped on cell 6-06 is reselected while the UE moves in the RRC_INACTIVE state, if the cell 6-06 is included in the validity area associated with (connected or related to) the previously activated SRS transmission configured, the UE 6-01 may use the previously activated (or previously used) SRS transmission configuration as it is without any separate activation procedure, and seamlessly perform SRS transmission 6-20. Alternatively, when a new serving/camped on cell 6-06 is reselected while the UE moves in the RRC_INACTIVE state, if the cell is not included in the validity area associated with (connected or related to) the previously activated SRS transmission configuration and not included in validity area(s) associated with (connected or related to) another “preconfigured” type SRS transmission configuration(s), the UE 6-01 may make a request for a new SRS transmission configuration from the gNB of the cell through the RRCResume procedure.

When the type of a specific SRS resource set included in the SRS transmission configuration is “periodic”, if the SRS transmission configuration is activated/applied, the UE may start SRS transmission by using resources of the SRS resource set. In contrast, when the type of a specific SRS resource set included in the SRS transmission configuration is “semi-persistent”, the UE may not immediately start SRS transmission by using resources of the SRS resource set even after the SRS transmission configuration is activated/applied. The UE may start SRS transmission by using resources of the SRS resource set after passing through a separate procedure for activation of the transmission of the “semi-persistent” type SRS resource set. For example, when the type of a specific SRS resource set included in the SRS transmission configuration is “semi-persistent”, even though the SRS transmission configuration is activated or applied, the UE may start SRS transmission by using resources of the SRS resource set after receiving an indication of activation of the transmission of the SRS resource set from the gNB through a MAC CE.

FIG. 7A illustrates a procedure in which the UE receives valid SRS transmission configuration information within a specific range from the gNB and activates SRS transmission in the RRC_INACTIVE state according to an embodiment.

Referring to FIG. 7A, a coordination procedure for SRS pre-configuration is performed in step 701a. In step 702a, a UE 7a-01 of which the location is to be estimated may receive an RRCRelease message from a gNB 7a-03 while operating in the RRC_CONNECTED state and may transition to the RRC_INACTIVE state. In the RRCRelease message, configuration information (for example, SRS-PosRRC-Inactive and/or srs-PosRRC-InactiveEnhanced) required for performing SRS transmission for location estimation in the RRC_INACTIVE state may be included. The configuration information may include one or more valid SRS transmission configurations (for example, SRS-PosRRC-InactiveValidityAreaConfig) valid in different validity areas. Each SRS transmission configuration may be associated with (connected or related to) an area/range (for example, srs-PosConfigValidityArea) in which the configuration information is valid. When an event that requires SRS transmission for location estimation is generated in the RRC_INACTIVE state, the UE 7a-01 may perform SRS transmission in the RRC_INACTIVE state by using SRS transmission configuration information given to the UE 7a-01 through the RRCRelease message.

When the UE 7a-01 receives a configuration of a “semi-persistent” type SRS resource set (for example, SRS-PosResourceSet) for location estimation through the RRCRelease message, if the UE 7a-01 needs SRS transmission for location estimation, the UE 7a-01 may make a request for activating transmission of the “semi-persistent” type SRS resource set to the gNB 7a-03 through transmission of an RRCResumeRequst message. The gNB 7a-03 may activate the “semi-persistent” type SRS resource set for location estimation through a MAC CE (for example, SP positioning SRS activation/deactivation MAC CE).

When a cell belonging to another validity area is reselected while the UE 7a-01 moves in the RRC_INACTIVE state, a procedure for activating or applying the “preconfigured” type SRS transmission configuration (for example, srs-PosRRC-InactiveValidityAreaPreConfigList-r18) preconfigured as necessary may be performed.

All the steps illustrated in FIG. 7A do not have to be included according to configurations and/or definition of the system, or the like, and some steps may be omitted.

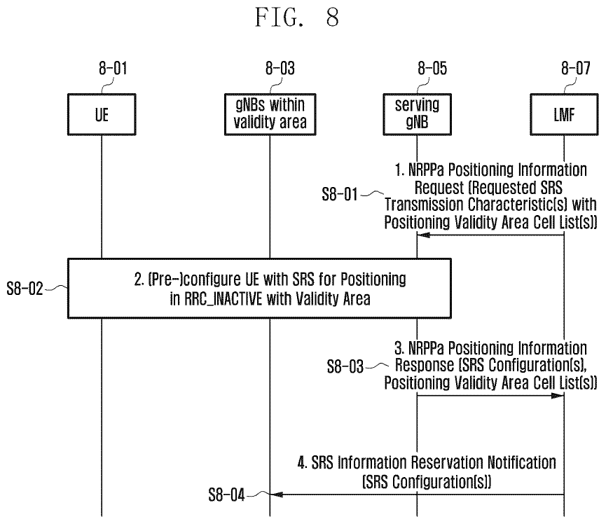

In step 701a, the LMF 7a-09 and/or gNBs 7a-03 and 7a-05 may perform a procedure for constructing configuration information (for example, srs-PosRRC-InactiveEnhanced) required for performing SRS transmission of location estimation in the RRC_INACTIVE state by the UE 7a-01 of which the location is to be estimated. Detailed interaction between the LMF 7a-09 and/or gNBs 7a-03 and 7a-05 for performing step 701a is described below with reference to FIG. 8.

In step 702a, the serving gNB 7a-05 may transition the UE 7a-01 to the RRC_INACTIVE state by transmitting the RRCRelease message to the UE 7a-01 operating in the RRC_CONNECTED state. In the RRCRelease message, one or more “preconfigured” type SRS transmission configurations (for example, SRS-PosRRC-InactiveValidityAreaConfig) may be included in the list form (for example, SRS-PosRRC-InactiveValidityAreaPreConfigList). Each SRS-PosRRC-InactiveValidityAreaConfig may be associated with (connected or related to) an area (for example, srs-PosConfigValidityArea, hereinafter, validity area) in which the configuration information is valid. The “preconfigured” type SRS transmission configuration may be activated/applied after a time point at which the UE 7a-01 makes a request for/report activation of the configuration to the gNB 7a-05 through transmission of the RRCResumeRequest message within the validity area associated with (connected or related to) the configuration and receives the RRCRelease message corresponding thereto. The RRCRelease message may include a maximum of one “non-preconfigured” type SRS transmission configuration (for example, SRS-PosRRC-InactiveValidityAreaConfig) as srs-PosRRC-InactiveValidityAreaNonPreConfig. The SRS transmission configuration may be related to the validity area including the current serving cell 7a-05. The “non-preconfigured” type SRS transmission configuration may be activated/applied immediately at a time point at which the UE 7a-01 receives the RRCRelease message including the configuration.

When the SRS should be immediately transmitted for location estimation after the UE 7a-01 of which the location is to be estimated transitions to the RRC_INACTIVE state, the gNB 7a-05 may include the “non-preconfigured” type SRS transmission configuration associated with (connected or related to) the validity area including the current serving cell 7a-05 of the UE 7a-01 in the RRCRelease message. The SRS transmission configuration may include one or more “periodic” type SRS resource sets. The UE 7a-01 of which the location is to be estimated may omit a separate activation procedure (for example, steps S7a-04 and S7a-05) after receiving the RRCRelease message, immediately apply/activate the SRS transmission configuration, and perform SRS transmission by using the “periodic” type SRS resource set included in the SRS transmission configuration. In contrast, when the SRS does not have to be immediately transmitted for location estimation after the UE 7a-01 of which the location is to be estimated transitions to the RRC_INACTIVE state, the gNB 7a-05 may include the “non-preconfigured” type SRS transmission configuration connected to the validity area including the current serving cell 7a-05 of the UE 7a-01 in the RRCRelease message. The SRS transmission configuration may include only the “semi-persistent” type SRS resource set. Even though the SRS transmission configuration is applied/activated after the UE 7a-01 of which the location is to be estimated receives the RRCRelease message, the actual “semi-persistent” type SRS resource set transmission may not be activated. In other words, when the SRS transmission configuration includes only the “semi-persistent” type SRS resource set, the actual SRS transmission may not be immediately performed and may be performed after a separate activation procedure (for example, steps S7a-04 and 7a-05) is performed.

In step 703a, the UE 7a-01 may detect an event that requires SRS transmission in the RRC_INACTIVE state for location estimation. When the UE 7a-01 is already performing SRS transmission for location estimation according to the SRS transmission configuration included in the RRCRelease message in step 702a, a higher layer (for example, LPP) related to location estimation of the UE 7a-01 may not make a request for activating SRS transmission to the RRC layer. When the higher layer does not make a request for activating SRS transmission to the RRC layer, steps 704a, 705a, and 706a for activating SRS transmission may not be performed.

In contrast, when the UE 7a-01 is not performing SRS transmission for the current location estimation according to the SRS transmission configuration included in the RRCRelease message in step 702a, the higher layer (for example, LPP) related to location estimation of the UE 7a-01 may make a request for activating SRS transmission to the RRC layer. When the higher layer makes a request for activating SRS transmission to the RRC layer, the RRC layer of the UE 7a-01 may start (trigger) an operation of transmitting the RRCResumeRequest message in step 704a below to activate the SRS transmission.

When the RRC layer of the UE 7a-01 triggers the RRCResumeRquest transmission procedure according to the higher layer request as in step 703a, the UE 7a-01 may transmit the RRCResumeRequest message to the gNB 7a-05 to activate or start SRS transmission for location estimation in step 704a. The UE 7a-01 may configure a resume cause value included in the RRCResumeRequest message as “srs-PosConfigOrActivationReq”. For example, according to the SRS transmission configuration information included in the RRCRelease message in step 702a, the UE 7a-01 may start (trigger) the RRCResumeRequest message transmission procedure, based on cases described below, and configure the resume cause value as “srs-PosConfigOrActivationReq”. The gNB 7a-05 may interpret (or determine) the intent of the resume cause value which the UE 7a-01 included in the RRCResumeRequest message in accordance with each case.

Case 1: When the SRS transmission configuration information included in the RRCRelease message in step 702a does not include SRS transmission configuration information valid in the serving cell 7a-05 of the current UE 7a-01 (for example, when the SRS transmission configuration connected to the validity area including the current serving cell 7a-05 is not included in the RRCRelease message), the UE 7a-01 may start the RRC connection resume procedure to make a request for a new SRS transmission configuration for location estimation. Accordingly, the gNB 7a-05 may interpret/understand (or determine) that the UE 7a-01 makes a request for a new SRS transmission configuration for location estimation. When the UE 7a-01 starts the RRC connection resume procedure, the SRS transmission configuration valid in the current cell 7a-05 may be included in the RRCRelease message in step 705a below. When the “semi-persistent” type SRS resource set is included in the SRS transmission configuration, the gNB 7a-05 may transmit a MAC CE for indicating activation of transmission of the SRS resource set to the UE 7a-01 along with the RRCRelease message.

Case 2: When the SRS transmission configuration information valid in the serving cell of the UE 7a-01 is currently included in the RRCRelease message in step 702a but the SRS transmission configuration is configured as the “preconfigured” type, the UE 7a-01 may start the RRC connection resume procedure to make a request for activating the SRS transmission configuration. When the UE 7a-01 starts the RRC connection resume procedure, the gNB 7a-05 may interpret/understand (or determine) that the UE 7a-01 makes a request for activating the SRS transmission configuration. According to case 2, the gNB 7a-05 may instruct/allow the UE 7a-01 to activate the SRS transmission configuration by transmitting the RRCRelease message of step 705a below. When the “semi-persistent” type SRS resource set is included in the SRS transmission configuration, the gNB 7a-05 may transmit a MAC CE for indicating activation of transmission of the SRS resource set to the UE 7a-01 along with the RRCRelease message.

Case 3: When the (for example, “non-preconfigured” type) SRS transmission configuration valid in the serving cell of the UE 7a-01 is currently included in the RRCRelease message in step 702a and the SRS transmission configuration includes one or more “semi-persistent” type SRS resource sets, the UE 7a-01 may start the RRC connection resume procedure to make a request for activating transmission of the “semi-persistent” type SRS resource set. When the UE 7a-01 starts the RRC connection resume procedure, the gNB 7a-05 may interpret/understand (or determine) that the UE 7a-01 makes a request for activating transmission of the “semi-persistent” type SRS resource set included in the SRS transmission configuration. The gNB 7a-05 may instruct the UE 7a-01 to activate transmission of the “semi-persistent” type SRS resource set by also transmitting the MAC CE (for example, SP positioning SRS activation/deactivation MAC CE) for indicating activation of the transmission of the SRS resource set while transmitting the RRCRelease message to the UE 7a-01 in step 705a below.

FIG. 7A illustrates an operation based on the assumption of case 3 (where a request for activating transmission of the “semi-persistent” type SRS resource set is made) among the cases. Accordingly, steps 704a-706a may be described for the operation based on the assumption of case 3 among the cases.

In step 705a, the gNB 7a-05 may allow the UE 7a-01 to perform SRS transmission after transitioning to the RRC_INACTIVE state by transmitting the RRCRelease message to the UE 7a-01. For example, the gNB 7a-05 may understand/interpret (or determine) that intention of ‘srs-PosConfigOrActivationReq’ corresponding to the resume cause value in the RRCResumeRequest message transmitted by the UE 7a-01 in step 704a is activation of transmission of the “semi-persistent” type SRS resource set. In this case, the gNB 7a-05 may indicate to activate one of the “semi-persistent” type SRS resource sets included in the SRS transmission configuration (for example, “non-preconfigured” type SRS transmission configuration or activated “preconfigured” type transmission configuration) valid in the current serving cell of the current UE 7a-01 by also transmitting the MAC CE (for example, SP positioning SRS activation/deactivation MAC CE) for indicating activation of transmission of the “semi-persistent” type SRS resource set while transmitting the RRCRelease message to the UE 7a-01.

When the number of “semi-persistent” type SRS resource sets included in the SRS transmission configuration valid in the serving cell of the current UE 7a-01 is plural, which one among them is to be selected and activated may be determined according to various implementations of the gNB. When the gNB 7a-05 desires to simultaneously activate a plurality of “semi-persistent” type SRS resource sets, the gNB 7a-05 may transmit a plurality of MAC CEs for indicating activation of each SRS resource set to the UE 7a-01 along with the RRCRelease message. Each MAC CE may include at least one piece of information on an ID value for indicating an SRS resource set to be activated or deactivated, an ID of a BWP in which the SRS resource set is configured, or transmission beam configuration information to be used for transmission per SRS resource constituting the SRS resource set (spatial relation information per SRS resource).

In step 706a, the gNB 7a-05 may inform the LMF 7a-09 that the UE 7a-01 of which the location is to be estimated activated/started SRS transmission for location estimation through an NRPPa positioning information update message. Through the NRPPa positioning information update message, the LMF 7a-09 may recognize which SRS resource set is used for location estimation to start SRS transmission by the UE 7a-01 of which the location is to be estimated. Thereafter, the LMF 7a-09 may instruct the neighbor gNB/TRP to receive the SRS transmitted in time/frequency resources corresponding to the SRS resource set. For example, the gNB 7a-05 may configure an SRS transmission status within the NRPPa positioning information update message as “area-specific SRS activated” and then transmit the same to the UE 7a-01. When the LMF 7a-09 receives the NRPPa positioning information update message in which the SRS transmission status is configured as “area-specific SRS activated” from the serving cell of the UE 7a-01, the LMF 7a-09 may detect that the UE 7a-01 activated the SRS transmission configuration for the validity area including the current serving cell and started SRS transmission by using SRS resource sets included in the configuration.

When the UE 7a-01 activates/applies a specific SRS transmission configuration, the UE 7a-01 may immediately start SRS transmission by using the “periodic” type SRS resource set included in the SRS transmission configuration. In step 701, the LMF 7a-09 may receive in advance SRS transmission configuration information transmitted to the UE 7a-01 through the RRCRelease message from the gNB 7a-05 in step 702a. Accordingly, when the gNB 7a-05 reports that the UE 7a-01 activated the SRS transmission configuration associated with (connected or related to) the validity area including the current serving cell to the LMF 7a-09, the LMF 7a-09 may detect that the UE 7a-01 is performing SRS transmission by using all “periodic” types of SRS resource set(s) included in the SRS transmission configuration. Thereafter, the LMF 7a-09 may instruct the neighbor gNBs/TRPs to measure the SRS.

However, when the “semi-persistent” type SRS resource set is included in the SRS transmission configuration, the transmission status configured as “area-specific SRS activated” in the NRPPa positioning information update message may not sufficiently provide information required by the LMF 7-09 to detect a transmission activation state of the “semi-persistent” type SRS resource set(s) included in the SRS transmission configuration. For example, when the LMF 7a-09 receives the NRPPa positioning information update message in which the transmission status is configured as “area-specific SRS activated” from the serving cell of the UE 7a-01 of which the location is to be estimated, the LMF 7a-09 may detect that the UE 7a-01 applied/activated the SRS transmission configuration connected to the validity area including the current serving cell but cannot determine whether transmission of the “semi-persistent” type SRS resource set(s) included in the SRS transmission configuration was also activated. In other words, the LMF 7a-09 may not detect whether the transmission status configured as “area-specific SRS activated” merely means application/activation of the SRS transmission configuration or additionally means activation of transmission of “semi-persistent” type SRS resource set(s) included in the SRS transmission configuration.

To solve such problems, disclosed is a scheme of introducing a new status (for example, SP-SRS activated) for reporting/indicating activation of transmission of the “semi-persistent” type SRS resource set(s) as a configuration value of a transmission status field within the NRPPa positioning information update message as shown in Table 1 below. In addition, a scheme of introducing a new status (for example, SP-SRS deactivated) for reporting or indicating deactivation of transmission of the “semi-persistent” type SRS resource set(s) is disclosed herein.

TABLE 1

| | | | | | | |
|---|---|---|---|---|---|---|
| IE/Group | | | IE type and | Semantics | | Assigned |
| Name | Presence | Range | reference | description | Criticality | Criticality |

| | | | | |
|---|---|---|---|---|
| Message | M | 9.2.3 | YES | ignore |
| Type | | | | |
| NRPPa | M | 9.2.4 | — | |
| Transaction | | | | |
| ID | | | | |
| SRS | O | 9.2.28 | YES | ignore |
| Configuration | | | | |
| SFN | O | Relative Time 1900 | YES | ignore |
| Initialization | | 9.2.36 | | |
| Time | | | | |
| UE Tx TEG | O | 9.2.78 | YES | ignore |
| Association | | | | |
| List | | | | |
| SRS | O | ENUMERATED | YES | ignore |
| Transmission | | (stopped, . . . , area- | | |
| Status | | specific SRS | | |
| | | activated, SP-SRS | | |
| | | activated, SP-SRS | | |
| | | deactivated) | | |
| New Cell | O | NR cell global | YES | ignore |
| Identity | | identity (CGI) | | |
| | | 9.2.9 | | |
| Remote UE | O | ENUMERATED(L2 | YES | ignore |
| Status | | U2N Remote, no, . . . ) | | |

When the SRS transmission configuration connected to the validity area including the current serving cell of the UE 7a-01 includes a plurality of “semi-persistent” type SRS resource sets and the LMF 7a-09 receives a report on activation of transmission of the “semi-persistent” type SRS resource set through the NRPPa positioning information update message, the LMF 7a-09 may not accurately detect which SRS resource set transmission is activated among the plurality of “semi-persistent” type SRS resource sets.

To solve such problems, disclosed is a scheme of limiting to include only one SRS resource set (for example, “semi-persistent” type SRS-PosResourceSet) in each SRS transmission configuration (for example, SRS-PosConfig included in the SRS-PosRRC-InactiveValidityAreaConfig IE) connected to each validity area included in the RRCRelease message of step. As each SRS transmission configuration includes only one (“semi-persistent” type) SRS resource set, when the LMF 7a-09 receives a report on the SRS transmission configuration or activation of the “semi-persistent” type SRS resource set through the NRPPa positioning information update message, the LMF 7a-09 may accurately detect which SRS resource set transmission is activated. The limitations may be described in the RRC specification. In addition, a scheme of introducing a field (for example, an activated SRS resource set ID) indicating an ID of the activated “semi-persistent” type SRS resource set in the NRPPa positioning information update message as shown in Table 2 below is disclosed herein. The ID may be configured as an integer value between 0 and 15 to indicate one of the SRS resource sets included in the SRS transmission configuration connected to the validity area included in the current serving cell of the UE 7a-01. For the same reason, a field (for example, deactivated SRS resource set ID) indicating an ID of the deactivated “semi-persistent” type SRS resource set may also be defined.

TABLE 2

| | | | | | | |
|---|---|---|---|---|---|---|
| IE/Group | | | IE type and | Semantics | | Assigned |
| Name | Presence | Range | reference | description | Criticality | Criticality |

| | | | | |
|---|---|---|---|---|
| Message Type | M | 9.2.3 | YES | ignore |
| NRPPa | M | 9.2.4 | — | |
| Transaction ID | | | | |
| SRS | O | 9.2.28 | YES | ignore |
| Configuration | | | | |
| SFN | O | Relative Time 1900 | YES | ignore |
| Initialization | | | | |
| Time | | 9.2.36 | | |
| UE Tx TEG | O | 9.2.78 | YES | ignore |
| Association | | | | |
| List | | | | |
| SRS | O | ENUMERATED | YES | ignore |
| Transmission | | (stopped, . . . , area- | | |
| Status | | specific SRS | | |
| | | activated) | | |
| New Cell | O | NR CGI | YES | ignore |
| Identity | | 9.2.9 | | |
| Remote UE | O | ENUMERATED | YES | ignore |
| Status | | (L2 U2N Remote, | | |
| | | no, . . . ) | | |
| Activated SRS | O | INTEGER (0 . . . 15) | YES | ignore |
| Resource Set | | | | |
| ID | | | | |
| Deactivated | O | INTEGER (0 . . . 15) | YES | ignore |
| SRS Resource | | | | |
| Set ID | | | | |

A scheme in which the gNB 7a-05 simultaneously activates a plurality of SRS resource sets among “semi-persistent” type SRS resource sets included in the SRS transmission configuration is further disclosed. When the plurality of SRS resource sets are simultaneously activated, the gNB 7a-05 may report ID values of the plurality of SRS resource sets of which transmission was activated to the LMF 7a-09 through the NRPPa message. For example, a field (for example, activated SRS resource set ID list) indicating a plurality of activated “semi-persistent” type SRS resource set IDs in the list form within the NRPPa positioning information update message may be introduced as shown in Table 3 below. The field may include a maximum of 16 ID values indicating one of the SRS resource sets included in the SRS transmission configuration. A field (for example, deactivated SRS resource set ID List) indicating a plurality of deactivated “semi-persistent” type SRS resource set IDs in the list form may also be introduced.

TABLE 3

| | | | | | | |
|---|---|---|---|---|---|---|
| IE/Group | | | IE type and | Semantics | | Assigned |
| Name | Presence | Range | reference | description | Criticality | Criticality |

| | | | | | |
|---|---|---|---|---|---|
| Message Type | M | | 9.2.3 | YES | ignore |
| NRPPa | M | | 9.2.4 | — | |
| Transaction ID | | | | | |
| SRS | O | | 9.2.28 | YES | ignore |
| Configuration | | | | | |
| SFN | O | | Relative Time | YES | ignore |
| Initialization | | | 1900 | | |
| Time | | | 9.2.36 | | |
| UE Tx TEG | O | | 9.2.78 | YES | ignore |
| Association | | | | | |
| List | | | | | |
| SRS | O | | ENUMERATED | YES | ignore |
| Transmission | | | (stopped, . . . , area- | | |
| Status | | | specific SRS | | |
| | | | activated) | | |
| New Cell | O | | NR CGI | YES | ignore |
| Identity | | | 9.2.9 | | |
| Remote UE | O | | ENUMERATED | YES | ignore |
| Status | | | (L2 U2N Remote, | | |
| | | | no, . . . ) | | |
| Activated SRS | O | 1 . . . <maxnoSRS- | | YES | ignore |
| Resource Set | | PosResourceSets | | | |
| ID List | | (=16)> | | | |
| >SRS | M | | INTEGER (0 . . . 15) | | |
| Resource Set | | | | | |
| ID | | | | | |
| Deactivated | O | 1 . . . <maxnoSRS- | | YES | ignore |
| SRS Resource | | PosResourceSets | | | |
| Set ID List | | (=16)> | | | |
| >SRS | M | | INTEGER (0 . . . 15) | | |
| Resource Set | | | | | |
| ID | | | | | |

A scheme of limiting the gNB 7a-05 to always activate or deactivate all “semi-persistent” type SRS resource sets included in the SRS transmission configuration together is disclosed instead of the serving gNB 7a-05 accurately indicating which set(s) transmission is (de)activated among a plurality of “semi-persistent” type SRS resource sets included in the SRS transmission configuration valid in the current serving cell of the UE 7a-01 to the LMF 7a-09. When the “semi-persistent” type SRS resource sets are activated or deactivated together, the LMF 7a-09 may detect that transmission of all “semi-persistent” type SRS resource sets included in the SRS transmission configuration was activated or deactivated when receiving a report on the SRS transmission configuration or activation of the “semi-persistent” type SRS resource set from the serving gNB 7a-05 through the NRPPa positioning information update message.

In step 707a, the UE 7a-01 transmitting the SRS for location estimation in the RRC_INACTIVE state may reselect another cell which does not belong to the validity area associated with (connected or related to) the previously activated or applied SRS transmission configuration. When the reselected cell belongs to another validity area associated with (connected or related to) one of the “preconfigured” type SRS transmission configurations (for example, SRS-PosRRC-InactiveValidityAreaConfig included in srs-PosRRC-InactiveValidityAreaPreConfigList) included in the RRCRelease message in step 702a and step 705a, the UE 7a-01 (or a higher layer of the UE 7a-01) may start the RRCResume procedure as in step 708a below to activate in advance the SRS transmission configuration.

When the RRC layer of the UE 7a-01 triggers the RRCResume procedure according to cell reselection during SRS transmission in the RRC_INACTIVE state as in step 707a, the UE 7a-01 may transmit an RRCResumeRequest message to the new serving gNB 7a-03 to activate/apply SRS-PosRRC-InactiveValidityAreaConfig connected to the validity area in which the current UE 7a-01 is located in step 708a. The UE 7a-01 may configure a resume cause value included in the RRCResumeRequest message as “srs-PosConfigOrActivationReq”.

In step 709a, the new serving gNB 7a-03 may detect that the UE 7a-01 make a request for or notify of activation of the preconfigured SRS transmission configuration, based on resume cause information in the RRCResumeRequest message received from the UE 7a-01 in step 708a. The gNB 7a-03 may make a request for UE CONTEXT information of the UE 7a-01 to the existing serving gNB 7a-05 to perform the operation requested by the UE 7a-01. To inform the existing serving gNB 7a-05 why the gNB 7a-03 made the request for UE CONTEXT information of the UE 7a-01, the resume cause value which the UE 7a-01 included in the RRCResumeRequest message may be included in a RETRIEVE UE CONTEXT REQUEST message in step 708a. When the new serving gNB 7a-03 cannot properly interpret (or determine) the resume cause value which the UE 7a-01 configured in the RRCResumeRequest message in step 708a, the gNB 7a-03 may immediately transition the UE 7a-01 to the RRC IDLE state through the RRCRelease message.

In step 710a, the existing serving gNB 7a-05 may report to the LMF 7a-09 that the UE 7a-01 of which the location is to be estimated activated a specific SRS transmission configuration of the “preconfigured” type configured in advance (for example, SRS-PosRRC-InactiveValidityAreaConfig) and started SRS transmission within the validity area connected to the configuration through the NRPPa positioning information update message. The NRPPa message may include an ID (for example, NR CGI) of the cell newly selected by the UE 7a-01. When the SRS transmission configuration valid in the new serving cell includes “semi-persistent” type SRS resource set(s), the existing serving gNB 7a-05 may determine to activate one or a plurality thereof. When the SRS transmission configuration includes “semi-persistent” type SRS resource set(s), SRS resource set ID values indicating SRS resource set(s) activated as in step 706a may also be included in the NRPPa message. As the LMF 7a-09 receives the NRPPa message, the LMF 7a-09 may detect that the UE 7a-01 escapes from the existing validity area (srs-PosConfigValidityArea), moves to a new validity area, and starts SRS transmission according to the SRS transmission configuration valid in the area. Thereafter, the LMF 7a-09 may instruct gNBs/TRPs measuring the SRS transmitted by the UE 7a-01 of which the location is to be estimated in the existing validity area to stop the SRS measurement operation. The LMF 7a-09 may instruct gNBs/TRPs to measure the SRS transmitted by the UE 7a-01 of which the location is to be estimated in the new validity area to measure and report the SRS as in step 508 of FIG. 5.

Alternatively, when the SRS transmission configuration valid in the new serving cell includes “semi-persistent” type SRS resource set(s), the existing serving gNB 7a-05 may make a request for activating the “semi-persistent” type SRS resource set(s) to the LMF 7a-09 instead of directly determining activation of one or a plurality thereof. More specifically, the existing serving gNB 7a-05 may make a request for activating “semi-persistent” type SRS resource set(s) through at least one combination of the method described below to the LMF 7a-09.

Method 1 introduces a new indicator or codepoint for making a request for activating an SP-SRS resource set. The existing serving gNB 7a-05 may transmit the NRPPa message (POSITIONING INFORMATION UPDATE) including an indicator (for example, an SP-SRS-activation request) indicating an activation request for “semi-persistent” type SRS resource set(s) to the LMF 7a-09. Alternatively, within the existing SRS transmission status IE, the codepoint (for example, SRS activation requested) indicating the activation request for “semi-persistent” type SRS resource set(s) may be introduced. The existing serving gNB 7a-05 may configure a value of the SRS transmission status IE included in the NRPPa message (POSITIONING INFORMATION UPDATE) as the new codepoint (for example, SRS activation requested) and then transmit the same to the LMF. To support the above-described method, the NRPPa message (POSITIONING INFORMATION UPDATE) may be improved as shown in Table 4 below.

TABLE 4

| | | | | | | |
|---|---|---|---|---|---|---|
| IE/Group | | | IE type and | Semantics | | Assigned |
| Name | Presence | Range | reference | description | Criticality | Criticality |

| | | | | |
|---|---|---|---|---|
| Message | M | 9.2.3 | YES | ignore |
| Type | | | | |
| NRPPa | M | 9.2.4 | — | |
| Transaction | | | | |
| ID | | | | |
| SRS | O | 9.2.28 | YES | ignore |
| Configuration | | | | |
| SFN | O | Relative Time | YES | ignore |
| Initialization | | 1900 | | |
| Time | | 9.2.36 | | |
| UE Tx TEG | O | 9.2.78 | YES | ignore |
| Association | | | | |
| List | | | | |
| SRS | O | ENUMERATED | YES | ignore |
| Transmission | | (stopped, . . . , | | |
| Status | | area-specific | | |
| | | SRS activated, | | |
| | | SRS activation | | |
| | | requested) | | |
| New Cell | O | NR CGI | YES | ignore |
| Identity | | 9.2.9 | | |
| Remote UE | O | ENUMERATED | YES | ignore |
| Status | | (L2 U2N | | |
| | | Remote, no, . . . ) | | |
| SP-SRS- | O | ENUMERATED | YES | ignore |
| activation | | (True) | | |
| request | | | | |

Method 2 reuses the existing SRS transmission status IE. The existing serving gNB 7a-05 may configure the SRS transmission status IE value in the NRPPa message (POSITIONING INFORMATION UPDATE) as “area-specific SRS activated” and transmit the same to the LMF 7a-09. When the SRS transmission configuration valid in the new serving cell includes “semi-persistent” type SRS resource set(s), the LMF may detect that the existing serving gNB 7a-05 makes a request for activating the “semi-persistent” type SRS resource set(s) through the SRS transmission Status IE value configured as “area-specific SRS activated” in the NRPPa message. For reference, the SRS transmission status IE value previously configured as “area-specific SRS activated” is used only for reporting that the gNB has already activated SRS transmission to the LMF. Accordingly, to use the SRS transmission status IE value configured as “area-specific SRS activated” for making a request for activating the “semi-persistent” type SRS resource set(s), the specification may be modified as shown in Table 5 below.

TABLE 5
If the SRS Transmission Status IE is included in the POSITIONING INFORMATION
UPDATE message and set to “stopped”, the LMF shall consider that the SRS transmission
has stopped. If the SRS Transmission Status IE is set to “area-specific SRS activated”,
the LMF shall consider the area-specific (pre-)configured SRS is activated or the activation
of the semi-persistent area-specific (pre-)configured SRS is requested in the current
serving cell.

As described above, when the existing serving gNB 7a-05 makes a request for activating the “semi-persistent” type SRS resource set(s) to the LMF 7a-09, the LMF 7a-09 may make a request for activating the “semi-persistent” type SRS resource set(s) by transmitting a POSITIONING ACTIVATION REQUEST message to the new serving gNB 7a-03 as described in procedure s3-05a of FIG. 3 after step 711a below. Thereafter, in step 712a below, the new serving gNB 7a-03 may transmit a MAC CE for instructing the UE to activate the “semi-persistent” type SRS resource set(s) as described in step 305b of FIG. 3. Subsequently, the new serving gNB 7a-03 may report activation of the “semi-persistent” type SRS resource set(s) by transmitting a POSITIONING ACTIVATION RESPONSE message to the LMF 7a-09 as described in step 305c of FIG. 3.

In step 711a, the existing serving gNB 7a-05 may transmit a RETRIEVE UE CONTEXT RESPONSE message to the new serving gNB 7a-03 in response to a RETRIEVE UE CONTEXT REQUEST message in step 709a. The RETRIEVE UE CONTEXT RESPONSE message may include a HandoverPreparationInformation message defined as the RRC specification as UE CONTEXT information required for the resume procedure. The HandoverPreparationInformation message may also include SRS configuration information (e.g., SRS-PosRRC-InactiveValidityAreaPreConfigList) configured in the UE 7a-01 through the RRCRelease message in step 702a and step 705a. The existing serving gNB 7a-05 may identify whether the resume procedure is related to the SRS transmission configuration, based on the resume cause value received from the new serving gNB 7a-03 in step 709a and determine whether to include the SRS configuration information in the RETRIEVE UE CONTEXT RESPONSE message (or HandoverPreparationInformation message).

When the UE 7a-01 starts the RRCResume procedure by configuring the resume cause value as “srs-PosConfigOrActivationReq” in step 708a, the existing serving gNB 7a-05 may include the SRS configuration information in the RETRIEVE UE CONTEXT RESPONSE message. Accordingly, the new serving gNB 7a-03 may detect which SRS transmission configuration the UE 7a-01 desires to activate in the validity area (srs-PosConfigValidityArea) included in the newly reselected cell. As described in step 709a, when the SRS transmission configuration valid in the new serving cell includes “semi-persistent” type SRS resource set(s) and the existing serving gNB 7a-05 determines to activate one or a plurality thereof, information (For example, an ID value of an SRS resource set which should be activated) for indicating SRS resource set(s) which should be activated may also be included in the RETRIEVE UE CONTEXT RESPONSE message. When the information for indicating the SRS resource set(s) which should be activated is not included in the RETRIEVE UE CONTEXT RESPONSE, mismatching may occur between the SRS resource sets (or activated SRS resource sets) reported to the LMF 7a-09 in step 710a and SRS resource sets of which actual transmission is activated by the new serving gNB 7a-03. However, when the SRS transmission configuration valid in the cell reselected by the UE 7a-01 includes “semi-persistent”type SRS resource set(s) and the new serving gNB 7a-03 determines SRS resource set(s) to be activated among them, information for indicating the SRS resource set(s) to be activated may not be included in the RETRIEVE UE CONTEXT RESPONSE message. When the new serving gNB 7a-03 determines SRS resource set(s) to be activated, the NRPPa positioning information update message in step 710a may also be transmitted to the LMF 7a-09 by the new serving gNB 7a-03 rather than the existing serving gNB 7a-05 after step 711a.

In step 712a, the serving gNB 7a-03 may allow SRS transmission after the UE transitions to the RRC_INACTIVE state by transmitting the RRCRelease message to the UE 7a-01. When the UE 7a-01 activates/applies the “preconfigured” type SRS transmission configuration connected to the validity area including the newly reselected cell and desires to also activate transmission of the “semi-persistent” type SRS resource set included in the SRS transmission configuration, the new serving gNB 7a-03 may transmit a MAC CE (for example, SP positioning SRS activation/deactivation MAC CE) for activating transmission of the SRS resource set for location estimation to the UE 7a-01 along with the RRCRelease.

FIG. 7B illustrates a procedure in which the UE receives valid SRS transmission configuration information within a specific range from the gNB and activates SRS transmission in the RRC_INACTIVE state according to an embodiment.

Referring to FIG. 7B, in step 701b, the UE 7b-01 may receive the RRCRelease message from the gNB 7b-05 and transition to the RRC_INACTIVE state. In the RRCRelease message, configuration information (for example, SRS-PosRRC-Inactive and/or srs-PosRRC-InactiveEnhanced) required for performing SRS transmission for location estimation in the RRC_INACTIVE state may be included. The configuration information may include one or more SRS transmission configurations (for example, SRS-PosRRC-InactiveValidityAreaConfig) valid in different validity areas. Each SRS transmission configuration may be associated with (connected or related to) an area/range (for example, srs-PosConfigValidityArea) in which the configuration is valid. When an event that requires SRS transmission for location estimation is generated in the RRC_INACTIVE state, the UE 7b-01 may perform SRS transmission in the RRC_INACTIVE state by using SRS transmission configuration information given to the UE 7b-01 through the RRCRelease message.

When the UE 7b-01 receives a configuration of the “semi-persistent” type SRS resource set (for example, SRS-PosResourceSet) for location estimation through the RRCRelease message, if the UE 7b-01 needs SRS transmission for location estimation, the UE 7b-01 may make a request for activating transmission of the “semi-persistent” type SRS resource set to the gNB 7b-03 through transmission of an RRCResumeRequst message. The gNB 7b-03 may activate the “semi-persistent” type SRS resource set for location estimation through a MAC CE (for example, SP positioning SRS activation/deactivation MAC CE).

When a cell belonging to another validity area is reselected while the UE 7b-01 moves in the RRC_INACTIVE state, a procedure for activating or applying the “preconfigured” type SRS transmission configuration (for example, srs-PosRRC-InactiveValidityAreaPreConfigList-r18) preconfigured as necessary may be performed.

In step 702b, the serving gNB 7b-05 may transition the UE 7b-01 to the RRC_INACTIVE state by transmitting the RRCRelease message to the UE 7b-01 operating in the RRC_CONNECTED state. In the RRCRelease message, one or more “preconfigured” type SRS transmission configurations (for example, SRS-PosRRC-InactiveValidityAreaConfig) may be included in the list form (for example, SRS-PosRRC-InactiveValidityAreaPreConfigList). Each SRS-PosRRC-InactiveValidityAreaConfig may be associated with (connected or related to) an area (for example, srs-PosConfigValidityArea, hereinafter, validity area) in which the configuration information is valid. The “preconfigured” type SRS transmission configuration may be activated/applied after a time point at which the UE 7b-01 makes a request for/report activation of the configuration to the gNB 7b-05 through transmission of the RRCResumeRequest message within the validity area associated with (connected or related to) the configuration and receives a RRCRelease message corresponding thereto. In the RRCRelease message, a maximum of one “non-preconfigured” type SRS transmission configuration (for example, SRS-PosRRC-InactiveValidityAreaConfig) may be included as srs-PosRRC-InactiveValidityAreaNonPreConfig. The SRS transmission configuration may be related to the validity area including the current serving cell 7b-05. The “non-preconfigured” type SRS transmission configuration may be activated/applied immediately at a time point at which the UE 7b-01 receives the RRCRelease message including the configuration.

When the SRS should be immediately transmitted for location estimation after the UE 7b-01 of which the location is to be estimated transitions to the RRC_INACTIVE state, the gNB 7b-05 may include the “non-preconfigured” type SRS transmission configuration associated with (connected or related to) the validity area including the current serving cell 7b-05 of the UE 7b-01 in the RRCRelease message. The SRS transmission configuration may include one or more “periodic” type SRS resource sets. The UE 7b-01 of which the location is to be estimated may omit a separate activation procedure (for example, steps 704b, 709b, and 710b) after receiving the RRCRelease message, immediately apply/activate the SRS transmission configuration, and perform SRS transmission by using the “periodic” type SRS resource set included in the SRS transmission configuration. In contrast, when the SRS does not have to be immediately transmitted for location estimation after the UE 7b-01 of which the location is to be estimated transitions to the RRC_INACTIVE state, the gNB 7b-05 may include only the “semi-persistent” type SRS resource set while including the “non-preconfigured” type SRS transmission configuration connected to the validity area including the current serving cell 7b-05 of the UE 7b-01 in the RRCRelease message. Even though the SRS transmission configuration is applied/activated after the UE 7b-01 of which the location is to be estimated receives the RRCRelease message, the actual “semi-persistent” type SRS resource set transmission may not be activated. In other words, when the SRS transmission configuration includes only the “semi-persistent” type SRS resource set, the actual SRS transmission is not immediately performed but may be performed after a separate activation procedure (for example, steps 703b, 709b, and 710b) is performed.

In step 703b, the UE 7b-01 may detect an event that requires SRS transmission in the RRC_INACTIVE state for location estimation. When the UE 7b-01 is already performing SRS transmission for location estimation according to the SRS transmission configuration included in the RRCRelease message in step 702b, a higher layer (for example, LPP) related to location estimation of the UE 7b-01 may not make a request for activating SRS transmission to the RRC layer. When the higher layer does not make the request for activating SRS transmission to the RRC layer, procedures from step 704b below for activating the SRS transmission may not be performed. In contrast, when the UE 7b-01 is not performing SRS transmission for the current location estimation according to the SRS transmission configuration included in the RRCRelease message in step 702b, the higher layer (for example, LPP) related to location estimation of the UE 7b-01 may make the request for activating the SRS transmission to the RRC layer. When the higher layer makes the request for activating the SRS transmission to the RRC layer, the RRC layer of the UE 7b-01 may start (trigger) an operation of transmitting the RRCResumeRequest message in step 704b below to activate the SRS transmission.

Alternatively, the UE 7b-01 transmitting the SRS for location estimation in the RRC_INACTIVE state may reselect another cell which does not belong to the validity area associated with (connected or related to) the previously activated or applied SRS transmission configuration. When the reselected cell belongs to another validity area associated with (connected or related to) one of the “preconfigured” type SRS transmission configurations (for example, SRS-PosRRC-InactiveValidityAreaConfig included in srs-PosRRC-InactiveValidityAreaPreConfigList) included in the RRCRelease message in step 702b, the UE 7b-01 (or a higher layer of the UE 7b-01) may start the RRCResume procedure as in step 708b below to activate in advance the SRS transmission configuration.

When the RRCResume procedure is triggered on the RRC layer of the UE 7b-01 for SRS transmission activation according to cell reselection during SRS transmission in the RRC_INACTIVE state or a request from the higher layer as in step 703b, the UE 7b-01 may transmit an RRCResumeRequest message to the new serving gNB 7b-03 to activate/apply SRS-PosRRC-InactiveValidityAreaConfig connected to the validity area in which the current UE 7b-01 is located in step 704b. The UE 7b-01 may configure a resume cause value included in the RRCResumeRequest message as “srs-PosConfigOrActivationReq”.

Thereafter, the new serving gNB 7b-03 may start the procedure for activating SRS transmission of the corresponding UE 7b-01 for location estimation according to the UE request. More specifically, the gNB may perform a procedure required for instructing the UE to activate transmission of the “periodic” or “semi-persistent” type SRS resource set included in the SRS transmission configuration (for example, SRS-PosRRC-InactiveValidityAreaConfig or srs-PosRRC-InactiveValidityAreaNonPreConfig) within the RRCRelease message transmitted to the UE in step 702b. To this end, a combination of at least one of the schemes described below may be used.

Scheme 1 in step 705b is performed to determine an SRS resource set to be activated by a new gNB without anchor relocation. When the UE 7b-01 reselects a new cell, a request for activating SRS transmission may be made to the new serving gNB 7b-03 operating the corresponding cell in step 704b. The new serving gNB 7b-03 receiving the request may identify the SRS transmission configuration valid in the new serving cell reselected by the UE and, when there is the “semi-persistent” type SRS resource set in the corresponding SRS transmission configuration, determine by itself which SRS resource set to activate. The new serving gNB 7b-03 should be able to detect in advance SRS transmission configuration information provided to the corresponding UE 7b-01 in step 702b. To this end, the LMF may transmit together an ID value (for example, I-RNTI) of the UE 7b-01 of which the location is to be estimated and SRS transmission configuration information to be provided to the corresponding UE through step 713b within the SRS INFORMATION RESERVATION NOTIFICATION transmitted to the new serving gNB 7b-03 in step 701b. A detailed procedure in which the LMF transmits the SRS INFORMATION RESERVATION NOTIFICATION to the new serving gNB 7b-03 in step 701b is as described in FIG. 8 below.

As described above, after determining a resource set to be activated among the “semi-persistent” type SRS resource sets configured in the UE 7b-01 of which the location is to be estimated, the new serving gNB 7b-01 may transfer a RETRIEVE UE CONTEXT REQUEST message including ID value(s) of SRS resource set to be activated to the existing serving gNB 7b-05 in step S7-051. Thereafter, in step 705b, the existing serving gNB 7b-05 may also include the ID value(s) of the SRS resource set to be activated in the message while transmitting again the POSITIONING INFORMATION UPDATE message to the LMF 7b-09. The LMF 7b-09 may detect which SRS resource set is used to perform SRS transmission by the UE of which the location is to be estimated based on the corresponding information and instruct adjacent TRPs to measure the corresponding SRS resource set. In step 7053, the existing serving gNB 7b-05 may transmit a RETRIEVE UE CONTEXT FAILURE message to the new serving gNB 7b-03 to indicate that an anchor relocation (change in an anchor gNB) operation is not performed. Thereafter, in step 709b, the new serving gNB 7b-03 may transmit a MAC CE (SP positioning SRS activation/deactivation MAC CE) for activating “semi-persistent” type SRS resource sets determined to be activated. Subsequently, in step 710b, the new serving gNB 7b-03 may instruct/allow the corresponding UE to perform again SRS transmission in the RRC_INACTIVE state by transmitting the RRCRelease message to the UE 7b-01. For reference, transmission of the MAC CE in step 709b and transmission of the RRCRelease message in step 710b may be performed together (simultaneously through transmission of one DL transmit block).

Scheme 2 in step 706b is performed to determine an SRS resource set to be activated by a new gNB without anchor relocation and use PARTIAL UE CONTEXT. When the UE 7b-01 reselects a new cell, a request for activating SRS transmission to the new serving gNB 7b-03 operating the corresponding cell may be made in step 704b. The new serving gNB 7b-03 receiving the request may identify the SRS transmission configuration valid in the new serving cell reselected by the UE and, when there is the “semi-persistent” type SRS resource set in the corresponding SRS transmission configuration, determine by itself which SRS resource set to activate. The new serving gNB 7b-03 should be able to detect SRS transmission configuration information provided to the corresponding UE 7b-01 in step 713b. To this end, in step 7061, the new serving gNB 7b-03 may make a request for transmitting PARTIAL UE CONTEXT TRANSFER by transmitting a RETRIEVE UE CONTEXT REQUEST message to the existing serving gNB 7b-05. In step 7062, the existing serving gNB 7b-05 may transmit the PARTIAL UE CONTEXT TRANSFER to the new serving gNB 7b-03. At this time, in the PARTIAL UE CONTEXT TRANSFER message, the SRS transmission configuration (more specifically, the “preconfigured” type SRS transmission configuration valid in the current serving cell) included in the RRCRelease message transmitted to the UE 7b-01 in step 702 may be included. Accordingly, the new serving gNB 7b-03 may detect which “semi-persistent” type SRS resource set(s) are included in the SRS transmission configuration (SRS-PosRRC-InactiveValidityAreaConfig) valid in the serving cell of the current UE and determine SRS resource set(s) of which transmission is to be activated. Thereafter, in step 7063, the new serving gNB 7b-03 may transfer a PARTIAL UE CONTEXT TRANSFER ACKNOWLEDGE message including ID value(s) of the SRS resource set to be activated to the existing serving gNB 7b-05. Subsequently, in step 7064, the existing serving gNB 7b-05 may transmit again the POSITIONING INFORMATION UPDATE message to the LMF 7b-09. The existing serving gNB 7b-05 may also include ID value(s) of the SRS resource set to be activated in the POSITIONING INFORMATION UPDATE message. The LMF 7b-09 may detect which SRS resource set is used to perform SRS transmission, based on the corresponding information, by the UE of which the location is to be estimated and instruct adjacent TRPs to measure the corresponding SRS resource set. In step 7065, the existing serving gNB 7b-05 may transmit the RETRIEVE UE CONTEXT FAILURE message to the new serving gNB 7b-03 to indicate that the anchor relocation (change in the anchor gNB) operation is not performed. Thereafter, in step 709b, the new serving gNB 7b-03 may transmit a MAC CE (SP positioning SRS activation/deactivation MAC CE) for activating “semi-persistent” type SRS resource sets determined to be activated. Subsequently, in step 710b, the new serving gNB 7b-03 may instruct/allow the corresponding UE to perform again SRS transmission in the RRC_INACTIVE state by transmitting the RRCRelease message to the UE 7b-01. For reference, transmission of the MAC CE in step 709b and transmission of the RRCRelease message in step 710b may be performed together (simultaneously through transmission of one DL transmit block).

Scheme 3 in step 707b is performed to determine an SRS resource set to be activated by the existing gNB without anchor relocation. When the UE 7b-01 reselects a new cell, the UE 7b-01 may make a request for activating SRS transmission to the new serving gNB 7b-03 operating the corresponding cell in step 704. In step 7071, the new serving gNB 7b-03 receiving the request may transfer a request for activating SRS transmission of the UE by transmitting a RETRIEVE UE CONTEXT REQUEST message to the existing serving gNB. To this end, information for indicating the request for activating SRS transmission of the UE (for example, the RRCResume message transmitted in step 704b or the resume cause value included in the corresponding message) may be included in the RETRIEVE UE CONTEXT REQUEST message. Thereafter, the existing serving gNB 7b-05 may identify the SRS transmission configuration valid in the new serving cell reselected by the UE and, when there is the “semi-persistent” type SRS resource set in the corresponding SRS transmission configuration, determine which SRS resource set to activate. Subsequently, in step 7072, the existing serving gNB 7b-05 may transmit a POSITIONING INFORMATION UPDATE message to the LMF 7b-09. The existing serving gNB 7b-05 may also include ID value(s) of the SRS resource set to be activated in the POSITIONING INFORMATION UPDATE message.

The LMF 7b-09 may detect which SRS resource set is used to perform SRS transmission by the UE of which the location is to be estimated based on the corresponding information and instruct adjacent TRPs to measure the corresponding SRS resource set. In step 7073, the existing serving gNB 7b-05 may transmit a RETRIEVE UE CONTEXT FAILURE message to the new serving gNB 7b-03 to indicate that an anchor relocation (change in an anchor gNB) operation is not performed. Thereafter, in step 709b, the new serving gNB 7b-03 may transmit an SP positioning SRS activation/deactivation MAC CE) for activating “semi-persistent” type SRS resource sets determined to be activated. Subsequently, in step 710b, the new serving gNB 7b-03 may instruct/allow the corresponding UE to re-perform SRS transmission in the RRC_INACTIVE state by transmitting the RRCRelease message to the UE 7b-01. For reference, transmission of the MAC CE in step 709b and transmission of the RRCRelease message in step 710b may be performed together (simultaneously through transmission of one DL transmit block).

Scheme 4 in step 708b is performed to determine an SRS resource set to be activated by the LMF without anchor relocation. When the UE 7b-01 reselects a new cell, the UE 7b-01 may make a request for activating SRS transmission to the new serving gNB 7b-03 operating the corresponding cell in step 704b. In step 7081, the new serving gNB 7b-03 receiving the request may transfer a request for activating SRS transmission of the UE by transmitting a RETRIEVE UE CONTEXT REQUEST message to the existing serving gNB. To this end, information for indicating the request for activating SRS transmission of the UE (for example, the RRCResume message transmitted in step 704b or the resume cause value included in the corresponding message) may be included in the RETRIEVE UE CONTEXT REQUEST message. Thereafter, the existing serving gNB 7b-05 may identify the SRS transmission configuration valid in the new serving cell reselected by the UE and, when there is the “semi-persistent” type SRS resource set in the corresponding SRS transmission configuration, make a request for activating transmission of the “semi-persistent” type SRS resource set to the LMF. To this end, the existing serving gNB 76-05 may transmit the POSITIONING INFORMATION UPDATE message to the LMF 7b-09 in step 7082.

The existing serving gNB 7b-05 may make a request for activating “semi-persistent” type SRS resource set(s) through a combination of at least one of the methods described in step 710a of FIG. 7A. The LMF 7b-09 receiving the request for activating the “semi-persistent” type SRS resource set(s) may make a request for activating SRS resource set(s) to be activated by determining the SRS resource set(s) to be activated and transmitting a POSITIONING ACTIVATION REQUEST message to the existing serving gNB 7b-05 in step 7083. To this end, the POSITIONING ACTIVATION REQUEST message may include ID values of the SRS resource set(s) to be activated. In step 7084, the existing serving gNB 7b-05 may report activation of the “semi-persistent” type SRS resource set(s) by transmitting a POSITIONING ACTIVATION RESPONSE message to the LMF 7a-09 as described in procedure s3-05c of FIG. 3. In step 7085, the existing serving gNB 7b-05 may transmit a RETRIEVE UE CONTEXT FAILURE message to the new serving gNB 7b-03 to indicate that an anchor relocation (change in an anchor gNB) operation is not performed. The existing serving gNB 7b-05 may instruct/make a request for activation of the corresponding SRS resource set(s) to the new serving gNB 7b-03 by including ID values of the “semi-persistent” type SRS resource set(s) to be activated in the RETRIEVE UE CONTEXT FAILURE message.

The serving gNB 7b-05 may also include information indicating the beam direction in which the SRS resource set(s) should be transmitted (in other words, spatial relation information) in the RETRIEVE UE CONTEXT FAILURE message in units of SRS resource set(s). Thereafter, in step 709b, the new serving gNB 7b-03 may transmit a MAC CE (SP positioning SRS activation/deactivation MAC CE) for activating “semi-persistent” type SRS resource sets determined to be activated. Subsequently, in step 710b, the new serving gNB 7b-03 may instruct/allow the corresponding UE to perform again SRS transmission in the RRC_INACTIVE state by transmitting the RRCRelease message to the UE 7b-01. For reference, transmission of the MAC CE in step 709b and transmission of the RRCRelease message in step 710b may be performed together (simultaneously through transmission of one DL transmit block).

FIG. 8 illustrates a procedure in which the gNB prepares valid SRS transmission configuration information within a specific range according to an embodiment.

Referring to FIG. 8, an LMF 8-07 may make a request for configuring the UE 8-01 to transmit an SRS for location estimation while traveling around a specific range in the RRC_INACTIVE state to a serving gNB 8-05 of the UE 8-01. The serving gNB 8-05 may transfer configuration information required by the UE 8-01 in the RRC_INACTIVE state to transmit the SRS for location estimation within a specific validity area to the UE 8-01 according to a request from the LMF 8-07. Thereafter, the serving gNB 8-05 may report SRS transmission configuration information configured in the UE 8-01 to the LMF 8-07. To allow the SRS transmission configuration which the serving gNB 8-05 configured in the UE 8-01 to be used by all of the cells included in the validity area associated with (connected or related to) the transmission configuration, the LMF 8-07 may instruct the gNBs 8-03 transmitting signals of the cells included in the validity area to secure/reserve in advance SRS transmission resources corresponding to the SRS transmission configuration.

All the steps illustrated in FIG. 8 do not have to be included according to configurations and/or definition of the system, or the like, and some steps may be omitted.

In step 801, the LMF 8-07 may transmit an NRPPa positioning information request message to the serving gNB 8-05 to make a request for allocating the SRS transmission configuration (for example, Area-specific SRS configuration or SRS-PosRRC-InactiveValidityAreaConfig) valid in a specific area to the serving gNB 8-05 of the UE 8-01 of which the location is to be estimated. When the LMF 8-07 make a request for the “non-preconfigured” type SRS transmission configuration valid in the specific area including the current serving cell, information indicating characteristics of the requested SRS transmission configuration (for example, requested SRS transmission characteristics) may be included in the NRPPa message, and information indicating characteristics of the SRS transmission configuration (for example, requested SRS transmission characteristics) may include a list of cells (for example, positioning validity area cell list) indicating one validity area associated with (connected or related to) the SRS transmission configuration.

In contrast, when the LMF 8-07 makes a request for a plurality of “preconfigured” type SRS transmission configuration(s) valid in a specific area(s) other than the area including the current serving cell, a list of information (for example, requested SRS preconfiguration characteristics list) indicating characteristics of the requested SRS transmission configuration may be included in the NRPPa message, and each piece of SRS transmission configuration characteristic information (for example, requested SRS transmission characteristics) included in the list may include a list of cells (for example, positioning validity area cell list) indicating one validity area associated with (connected or related to) each piece of the SRS transmission configuration characteristic information.

In step 802, the serving gNB 8-05 may allocate SRS transmission resources valid in a specific area to the UE 8-01 and transmit the RRCRelease message to the UE 8-01 to transition the UE 8-01 to the RRC_INACTIVE state. The RRCRelease message may include a plurality of SRS transmission configurations (for example, Area-specific SRS configuration or SRS-PosRRC-InactiveValidityAreaConfig) associated with (connected or related to) the specific validity area. A maximum of one of the SRS transmission configurations may be configured as the “non-preconfigured” type, and a plurality of remaining SRS transmission configurations may be configured as the “preconfigured” type. Each SRS transmission configuration (SRS configuration) may include a plurality of SRS resource sets, and each SRS resource set may be constituted by a plurality of SRS resources. The SRS resources may include information for indicating detailed resources in time and frequency domains used to transmit the SRS.

In step 803, the serving gNB 8-05 may transmit an NRPPa positioning information response message to the LMF 8-07 in response to the NRPPa positioning information request message in step 801. The NRPPa positioning information response message may include one or a plurality of SRS transmission configurations (SRS configurations) transferred to the UE 8-01 in step 802 as shown in Table 6 below. The “SRS configuration” may be understood as information corresponding to “SRS-PosRRC-InactiveValidityAreaConfig” configured in the UE 8-01 in the embodiment of FIG. 7.

TABLE 6

| | | | | | | |
|---|---|---|---|---|---|---|
| IE/Group | | | IE type and | Semantics | | Assigned |
| Name | Presence | Range | reference | description | Criticality | Criticality |

| | | | | |
|---|---|---|---|---|
| Message Type | M | 9.2.3 | YES | reject |
| NRPPa | M | 9.2.4 | — | |
| Transaction ID | | | | |
| SRS | O | 9.2.28 | YES | ignore |
| Configuration | | | | |
| SFN | O | Relative Time | YES | ignore |
| Initialization | | 1900 | | |
| Time | | 9.2.36 | | |
| Criticality | O | 9.2.2 | YES | ignore |
| Diagnostics | | | | |
| UE Tx TEG | O | 9.2.78 | YES | ignore |
| Association List | | | | |
| New NR CGI | O | NR CGI | YES | ignore |
| | | 9.2.9 | | |
| Positioning | O | 9.2.93 | YES | ignore |
| Validity Area | | | | |
| Cell List | | | | |
| SRS | O | 9.2.98 | YES | ignore |
| Preconfiguration | | | | |
| List | | | | |
| Remote UE- | O | ENUMERATED | YES | ignore |
| Indication | | (L2 U2N | | |
| | | Remote, . . . ) | | |

For example, the “non-preconfigured” type SRS transmission configuration (SRS configuration) configured in the UE 8-01 in step 802 and the validity area cell list (positioning validity area cell list) corresponding thereto may be included in the NRPPa positioning information response message. The “preconfigured” type SRS transmission configurations configured in the UE 8-01 in step 802 may be included in the NRPPa positioning information response message in the list form (SRS preconfiguration list). The SRS preconfiguration list may include a plurality of SRS transmission configurations (SRS configuration) configured as the “preconfigured” type as shown in Table 7 below and the validity area cell list (positioning validity area cell list) associated with (connected or related to) each configuration.

TABLE 7

| | | | | |
|---|---|---|---|---|
| | | | IE type and | Semantics |
| IE/Group Name | Presence | Range | reference | description |

| | | | |
|---|---|---|---|
| SRS | | 1 . . . <maxnoPreconfiguredSRS> | |
| Preconfiguration | | | |
| Item | | | |
| >SRS | M | | 9.2.28 |
| Configuration | | | |
| >Positioning | M | | 9.2.93 |
| Validity Area Cell | | | |
| List | | | |

In step 804, for each of the SRS transmission configurations provided from the serving gNB 8-05 in step 803, the LMF 8-07 may instruct the gNBs 8-03 included in the validity area (positioning validity area) associated with (connected or related to) the SRS transmission configuration to reserve SRS transmission resources corresponding to the SRS transmission configurations. To instruct the gNBs 8-03 to reserve SRS transmission resources corresponding to the SRS transmission configurations, the LMF 8-07 may transmit an NRPPa SRS information reservation notification message to the gNBs 8-03 included in the validity area (positioning validity area) associated with (connected or related to) the SRS transmission configurations. To indicate the SRS transmission resources which should be reserved to the gNBs 8-03 receiving the NRPPa message, the LMF 8-07 may include information indicating characteristics of the SRS transmission configuration (for example, requested SRS transmission characteristics) in the NRPPa message as shown in Table 8 below.

TABLE 8

| | | | | | | |
|---|---|---|---|---|---|---|
| IE/Group | | | IE type and | Semantics | | Assigned |
| Name | Presence | Range | reference | description | Criticality | Criticality |

| | | | | |
|---|---|---|---|---|
| Message | M | 9.2.3 | YES | reject |
| Type | | | | |
| NRPPa | M | 9.2.4 | — | |
| Transaction | | | | |
| ID | | | | |
| SRS | M | ENUMERATED | YES | ignore |
| Reservation | | (reserve, | | |
| Type | | release, . . . ) | | |
| SRS | O | Requested SRS | YES | ignore |
| Information | | Transmission | | |
| | | Characteristics | | |
| | | 9.2.27 | | |
| Preconfigured | O | Requested SRS | YES | ignore |
| SRS | | Preconfiguration | | |
| Information | | Characteristics | | |
| | | List | | |
| | | 9.2.97 | | |

For example, when the LMF 8-07 makes a request for reserving SRS transmission resources corresponding to the “non-preconfigured” type SRS transmission configuration, the LMF 8-07 may include information (for example, requested SRS transmission characteristics information configured through an SRS information field) indicating characteristics of the SRS transmission configuration corresponding to one SRS transmission configuration in the NRPPa message. In contrast, when the LMF 8-07 makes a request for reserving SRS transmission resources corresponding to the “preconfigured” type SRS transmission configuration, the LMF 8-07 may include information (for example, a list of requested SRS transmission characteristics information configured through a preconfigured SRS information field) indicating characteristics of a plurality of SRS transmission configurations corresponding to a plurality of SRS transmission configurations, respectively, in the NRPPa message. However, the requested SRS transmission characteristics information may be insufficient to specify a detailed resource area in time and frequency domains to be reserved for each of the SRS resources included in each SRS transmission configuration.

The requested SRS transmission characteristics information may include information such as the type of the SRS resource set required as information indicating required characteristics of the SRS transmission configuration for location estimation, the number of SRS resource sets, the number of SRS resources included in each SRS resource set, SRS transmission period, and SRS transmission frequency. However, the requested SRS transmission characteristics information may be insufficient to specify resources in detailed time and frequency domains that should be prepared for each SRS resource. Accordingly, the gNBs 8-03 receiving the NRPPa SRS information reservation notification may not accurately detect which resources should be specifically reserved in time and frequency domains and thus fail in reserving SRS transmission resources requested by the LMF 8-07.

To solve such problems, a scheme of including the SRS transmission configuration (for example, SRS configuration included in Tables 6 and 7 above) and/or the list of SRS transmission configurations (for example, SRS preconfiguration list included in Table 6] above), which the serving gNB 8-05 transferred to the LMF 8-07 in step 803, as they are in the NRPPa SRS information reservation notification message as shown in Table 9 below is disclosed herein.

TABLE 9

| | | | | | | |
|---|---|---|---|---|---|---|
| IE/Group | | | IE type and | Semantics | | Assigned |
| Name | Presence | Range | reference | description | Criticality | Criticality |

| | | | | |
|---|---|---|---|---|
| Message Type | M | 9.2.3 | YES | reject |
| NRPPa | M | 9.2.4 | — | |
| Transaction ID | | | | |
| SRS Reservation | M | ENUMERATED | YES | ignore |
| Type | | (reserve, | | |
| | | release, . . . ) | | |
| SRS Information | O | Requested SRS | YES | ignore |
| | | Transmission | | |
| | | Characteristics | | |
| | | 9.2.27 | | |
| Preconfigured | O | Requested SRS | YES | ignore |
| SRS Information | | Preconfiguration | | |
| | | Characteristics | | |
| | | List | | |
| | | 9.2.97 | | |
| SRS | O | 9.2.28 | YES | ignore |
| Configuration | | | | |
| SRS | O | 9.2.98 | YES | ignore |
| Preconfiguration | | | | |
| List | | | | |

Requested SRS transmission characteristics information included as SRS information in Table 9 above may be constructed as shown in Table 10 below.

TABLE 10

| IE/Group | | | IE Type and | Semantics | | Assigned |
|---|---|---|---|---|---|---|
| Name | Presence | Range | Reference | Description | Criticality | Criticality |
| Number Of | C- | | INTEGER | The number of | — | |
| Periodic | ifResourceTypePeriodic | | (0 . . . | periodic SRS | | |
| Transmissions | | | 500, . . . ) | transmissions | | |
| | | | | requested. | | |
| | | | | The value of | | |
| | | | | ‘0’ represents | | |
| | | | | an infinite | | |
| | | | | number of | | |
| | | | | periodic SRS | | |
| | | | | transmissions. | | |
| Resource | M | | ENUMERATED | | — | |
| Type | | | (periodic, | | | |
| | | | semi- | | | |
| | | | persistent, | | | |
| | | | aperiodic, . . . ) | | | |
| CHOICE | M | | | | — | |
| Bandwidth | | | | | | |
| >FR1 | | | ENUMERATED | | | |
| | | | (5 mHz, | | | |
| | | | 10 mHz, | | | |
| | | | 20 mHz, | | | |
| | | | 40 mHz, | | | |
| | | | 50 mHz, | | | |
| | | | 80 mHz, | | | |
| | | | 100 mHz, . . . , | | | |
| | | | 160 mHz, | | | |
| | | | 200 mHz, | | | |
| | | | 15 mHz, | | | |
| | | | 25 mHz, | | | |
| | | | 30 mHz, | | | |
| | | | 60 mHz, | | | |
| | | | 35 mHz, | | | |
| | | | 45 mHz, | | | |
| | | | 70 mHz, | | | |
| | | | 90 mHz) | | | |
| >FR2 | | | ENUMERATED | | | |
| | | | (50 mHz, | | | |
| | | | 100 mHz, | | | |
| | | | 200 mHz, | | | |
| | | | 400 mHz, . . . , | | | |
| | | | 600 mHz, | | | |
| | | | 800 mHz, | | | |
| | | | 1600 mHz, | | | |
| | | | 2000 mHz) | | | |
| SRS Resource | | 0 . . . 1 | | | — | |
| Set List | | | | | | |
| >SRS | | 1 . . . | | | — | |
| Resource Set | | <maxnoSRSResourceSets> | | | | |
| Item | | | | | | |
| >>Number | O | | INTEGER | The number of | — | |
| of SRS | | | (1 . . . | SRS | | |
| Resources | | | 16, . . . ) | Resources per | | |
| Per Set | | | | resource set | | |
| | | | | for SRS | | |
| | | | | transmission. | | |
| >>Periodicity | | 0 . . . 1 | | | — | |
| List | | | | | | |
| >>>Periodicity | | 1 . . . <maxnoSRS- | | | — | |
| List Item | | ResourcePerSet> | | | | |
| >>>>PeriodicitySRS | M | | ENUMERATED | Milli-seconds | — | |
| | | | (0.125, | | | |
| | | | 0.25, 0.5, | | | |
| | | | 0.625, 1, 1.25, | | | |
| | | | 2, 2.5, 4, 5, 8, | | | |
| | | | 10, 16, 20, 32, | | | |
| | | | 40, 64, 80, | | | |
| | | | 160, 320, 640, | | | |
| | | | 1280, 2560, | | | |
| | | | 5120, 10240, | | | |
| | | | . . . ) | | | |
| >>Spatial | O | | 9.2.34 | This IE is | — | |
| Relation | | | | ignored if the | | |
| Information | | | | Spatial | | |
| | | | | Relation | | |
| | | | | Information | | |
| | | | | per SRS | | |
| | | | | Resource IE is | | |
| | | | | present. | | |
| >>Pathloss | O | | 9.2.53 | | — | |
| Reference | | | | | | |
| Information | | | | | | |
| >>Spatial | O | | 9.2.60 | | — | |
| Relation | | | | | | |
| Information | | | | | | |
| per SRS | | | | | | |
| Resource | | | | | | |
| SSB | O | | 9.2.54 | | — | |
| Information | | | | | | |
| SRS | O | | INTEGER | NR ARFCN | YES | ignore |
| Frequency | | | (0 . . . 3279165) | The carrier | | |
| | | | | frequency of | | |
| | | | | SRS | | |
| | | | | transmission | | |
| | | | | bandwidth. | | |
| Bandwidth | O | | ENUMERATED | | YES | ignore |
| Aggregation | | | (true, . . . ) | | | |
| Request | | | | | | |
| Indication | | | | | | |
| Positioning | O | | 9.2.93 | | YES | ignore |
| Validity Area | | | | | | |
| Cell List | | | | | | |
| Validity Area | O | | 9.2.96 | | YES | ignore |
| Specific SRS | | | | | | |
| Information | | | | | | |

In the requested SRS transmission characteristics information, validity area specific SRS information may include information indicating resources in detailed time and frequency domains corresponding to one SRS resource. Accordingly, when the requested SRS transmission characteristics information is included in the SRS information reservation notification message transmitted in step 804, the LMF 8-07 may more specifically indicate time and frequency resources which should be reserved for SRS transmission of the UE 8-01 to the gNBs 8-03 receiving the message by including the validity area specific SRS information in the SRS information reservation notification message. Meanwhile, for actual location estimation of the UE, at least three SRS resources may be needed and, accordingly, a scheme of including a plurality of pieces of validity area specific SRS information in the SRS information reservation notification message in the list form is disclosed herein.

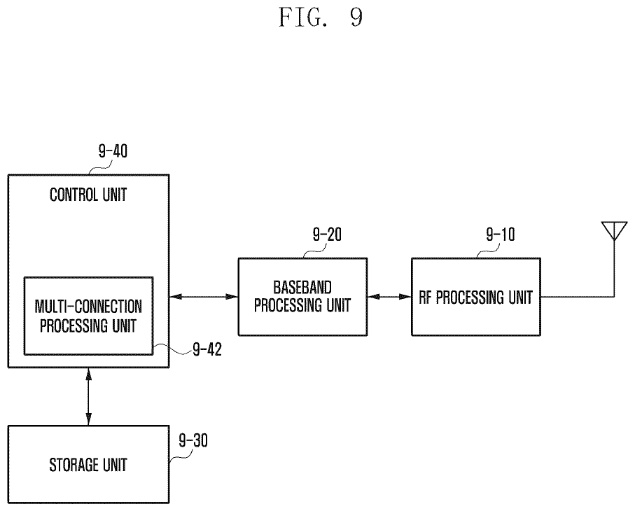

FIG. 9 illustrates an internal structure of the UE to which the disclosure is applied.

Referring to FIG. 9, the UE includes a radio frequency (RF) processing unit 9-10, a baseband processing unit 9-20, a storage unit 9-30, and a control unit 9-40.

The RF processing unit 9-10 performs a function of transmitting and receiving a signal through a radio channel such conversion of a band of a signal or amplification of a signal. That is, the RF processing unit 9-10 up-converts a baseband signal provided from the baseband processing unit 9-20 into an RF band signal, transmits the RF band signal through an antenna, and then down-converts the RF band signal received through the antenna into a baseband signal. For example, the RF processing unit 9-10 may include a transmission filter, a reception filter, an amplifier, a mixer, an oscillator, a digital-to-analog converter (DAC), an analog-to-digital converter (ADC), and the like. In the drawing, only one antenna is illustrated, but the UE may have a plurality of antennas. The RF processing unit 9-10 may include a plurality of RF chains. The RF processing unit 9-10 may perform beamforming. For the beamforming, the RF processing unit 9-10 may control a phase and a size of each of the signals transmitted and received through a plurality of antennas or antenna elements. The RF processing unit may perform MIMO and receive several layers when performing the MIMO operation.

The baseband processing unit 9-20 performs a function of conversion between a baseband signal and a bitstream according to a physical layer standard of the system. For example, when data is transmitted, the baseband processing unit 9-20 generates complex symbols by encoding and modulating a transmission bitstream. When data is received, the baseband processing unit 9-20 restores a reception bitstream by demodulating and decoding a baseband signal provided from the RF processing unit 9-10. For example, in an orthogonal frequency division multiplexing (OFDM) scheme, when data is transmitted, the baseband processing unit 9-20 may generate complex symbols by encoding and modulating the transmission bitstream, map the complex symbols to subcarriers, and then configure OFDM symbols through an inverse fast Fourier transform (IFFT) operation and cyclic prefix (CP) insertion. When data is received, the baseband processing unit 9-20 divides a baseband signal provided from the RF processing unit 9-10 in units of OFDM symbols, restores signals mapped with subcarriers through a fast Fourier transform (FFT) operation, and then restores a reception bitstream through demodulation and decoding.

The baseband processing unit 9-20 and the RF processing unit 9-10 transmits and receives a signal as described above. Accordingly, the baseband processing unit 9-20 and the RF processing unit 9-10 may be referred to as a transmitter, a receiver, a transceiver or a communication unit. At least one of the baseband processing 9-20 and the RF processing unit 9-10 may include a plurality of communication modules to support a plurality of different radio access technologies or different communication modules to process signals in different frequency bands. For example, the different radio access technologies may include a wireless local area network (WLAN) (for example, IEEE 802.11), a cellular network (for example, LTE), or the like. The different frequency bands may include a super high frequency (SHF) (for example, 2 .GHz) band and an mmwave (for example, 60 GHz) band.

The storage unit 9-30 stores data such as basic programs, application programs, and configuration information for the operation of the UE. Particularly, the storage unit 9-30 may store information related to the second access node performing wireless communication by using the second radio access technology. The storage unit 9-30 provides the stored data according to a request from the control unit 9-40.

The control unit 9-40 controls the overall operations of the UE. For example, the control unit 9-40 transmits and receives signals through the baseband processing unit 9-20 and the RF processing unit 9-10. The control unit 9-40 records data in the storage unit 9-30 and reads the data. To this end, the control unit 9-40 may include at least one processor. For example, the control unit 9-40 may include a communications processor (CP) that performs control for communication, and an application processor (AP) that controls higher layers such as an application layer.

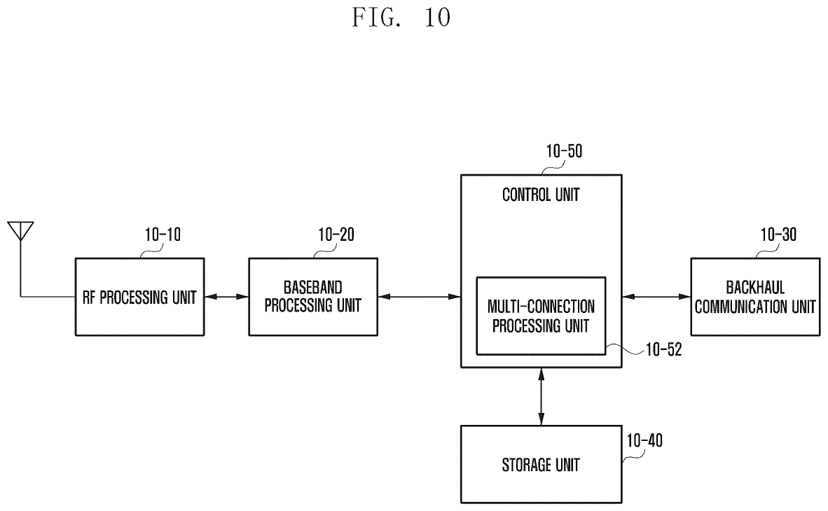

FIG. 10 illustrates the structure of the BS according to an embodiment.

Referring to FIG. 10, the BS includes an RF processing unit 10-10, a baseband processing unit 10-20, a backhaul communication unit 10-30, a storage unit 10-40, and a control unit 10-50.

The RF processing unit 10-10 performs a function of transmitting and receiving a signal through a radio channel such conversion of a band of a signal or amplification of a signal. That is, the RF processing unit 10-10 up-converts a baseband signal provided from the baseband processing unit 10-20 into an RF band signal and then transmits the RF band signal through an antenna, and down-converts an RF band signal received through the antenna into a baseband signal. For example, the RF processing unit 10-10 may include a transmission filter, a reception filter, an amplifier, a mixer, an oscillator, a DAC, an ADC, or the like. In the drawing, only one antenna is illustrated, but the first access node may have a plurality of antennas. The RF processing unit 10-10 may include a plurality of RF chains. The RF processing unit 10-10 may perform beamforming, for which the RF processing unit 10-10 may control a phase and a size of each of the signals transmitted and received through a plurality of antennas or antenna elements. The RF processing unit may perform the DL MIMO operation by transmitting one or more layers.

The baseband processing unit 10-20 performs a function of conversion between a baseband signal and a bitstream according to a physical layer standard of the first radio access technology. When data is transmitted, the baseband processing unit 10-20 generates complex symbols by encoding and modulating a transmission bitstream. When data is received, the baseband processing unit 10-20 restores a reception bitstream by demodulating and decoding a baseband signal provided from the RF processing unit 10-10. In an OFDM scheme, when data is transmitted, the baseband processing unit 10-20 may generate complex symbols by encoding and modulating the transmission bitstream, map the complex symbols to subcarriers, and then configure OFDM symbols through an IFFT operation and CP insertion. When data is received, the baseband processing unit 10-20 divides a baseband signal provided from the RF processing unit 10-10 in units of OFDM symbols, restores signals mapped to subcarriers through an FFT operation, and then restores a reception bitstream through demodulation and decoding. The baseband processing unit 10-20 and the RF processing unit 10-10 transmits and receives a signal as described above. Accordingly, the baseband processing unit 10-20 and the RF processing unit 10-10 may be referred to a transmitter, a receiver, a transceiver, a communication unit, or a wireless communication unit.

The backhaul communication unit 10-30 provides an interface for communicating with other nodes within the network. That is, the backhaul communication unit 10-30 converts a bitstream transmitted from the main BS to another node, for example, an auxiliary BS or a core network into a physical signal and converts a physical signal received from the other node into the bitstream.

The storage unit 10-40 stores data such as basic programs, application programs, and configuration information for the operation of the main BS. Particularly, the storage unit 10-40 may store information on bearers allocated to the accessed UE, the measurement result reported from the accessed UE, or the like. The storage unit 10-40 may store information that is the reference for determining whether to provide multiple connections to the UE or to stop the same. The storage unit 10-40 provides the stored data according to a request from the control unit 10-50.

The control unit 10-50 controls the overall operations of the main BS. For example, the control unit 10-50 transmits and receives a signal through the baseband processing unit 10-20 and the RF processing unit 10-10 or through the backhaul communication unit 10-30. The control unit 10-50 records data in the storage unit 10-40 and reads the data. To this end, the control unit 10-50 may include at least one processor.

It may be understood that each block in figures corresponding to processing flowcharts and combinations of the figures corresponding to the flowcharts can be executed by computer program instructions. Since these computer program instructions may be mounted in a processor of a general-purpose computer, a special-purpose computer, or other programmable data processing equipment, the instructions executed through a processor of a computer or other programmable data processing equipment generate a means that performs functions described in flowchart block(s). Since these computer program instructions can also be stored in a computer-available or computer-readable memory that may direct a computer or other programmable data processing equipment to implemented a function in a particular manner, the instructions stored in the computer-available or computer-readable memory can generate manufactured items including an instruction means that performs the functions described in the flowchart block(s). The computer program instructions can also be loaded onto a computer or other programmable data processing equipment to cause a series of operational steps to be performed on the computer or other programmable data processing equipment to produce a computer-implemented process such that the instructions executing the computer or other programmable data processing equipment provide steps for performing the functions described in the flowchart block(s).

Each block may indicate some of modules, segments, or codes including one or more executable instructions for performing specified logical function(s). In some alternative execution examples, it should also be noted that the mentioned functions in blocks can be generated out of order. For example, that two blocks illustrated in succession may actually be performed substantially simultaneously, or that the blocks may sometimes be performed in reverse order according to the corresponding function.

While the disclosure has been illustrated and described with reference to various embodiments of the present disclosure, those skilled in the art will understand that various changes can be made in form and detail without departing from the spirit and scope of the disclosure as defined by the appended claims and their equivalents.

What is claimed is:

1. A method performed by a first base station, the method comprising:
receiving, from a second base station, a retrieve user equipment (UE) context request message;
transmitting, to a location management function (LMF), a positioning information update message including sounding reference signal (SRS) transmission status information, wherein the SRS transmission status information is set to an area-specific SRS activated;
receiving, from the LMF, a positioning activation request message for activating a semi-persistent SRS resource set based on the SRS transmission status information; and
transmitting, to the second base station, a message including information on the semi-persistent SRS resource set, as a response to the retrieve UE context request message.

2. The method of claim 1,
wherein the information on the semi-persistent SRS resource set includes at least one of information indicating whether to activate the semi-persistent SRS resource set, an identifier of the semi-persistent SRS resource set, or spatial relation information for the semi-persistent SRS resource set.

3. The method of claim 1, further comprising:
receiving, from the LMF, an SRS information reservation notification including information on requested SRS transmission characteristics.

4. The method of claim 3,
wherein the SRS information reservation notification further includes an SRS resource list corresponding to an SRS-PosResource included in an SRS configuration information.

5. A method performed by a second base station, the method comprising:
transmitting, to a first base station, a retrieve user equipment (UE) context request message;
receiving, from the first base station, a message including information on a semi-persistent sounding reference signal (SRS) resource set, as a response to the retrieve UE context request message; and
transmitting, to the UE, a medium access control (MAC) control element (CE) for activating the semi-persistent SRS resource set,
wherein the information on the semi-persistent SRS resource set is based on a positioning activation request message transmitted for activating the semi-persistent SRS resource set based on SRS transmission status information, and
wherein the SRS transmission status information is set to an area-specific SRS activated.

6. The method of claim 5,
wherein the information on the semi-persistent SRS resource set includes at least one of information indicating whether to activate the semi-persistent SRS resource set, an identifier of the semi-persistent SRS resource set, or spatial relation information for the semi-persistent SRS resource set.

7. The method of claim 5, further comprising:
receiving, from the LMF, an SRS information reservation notification including at least one of information on requested SRS transmission characteristics or an SRS resource list corresponding to an SRS-PosResource included in an SRS configuration information.

8. A first base station comprising:
at least one transceiver;
at least one processor communicatively coupled to the at least one transceiver; and
at least one memory, communicatively coupled to the at least one processor, storing instructions executable by the at least one processor individually or in any combination to cause the first base station to:
receive, from a second base station, a retrieve user equipment (UE) context request message,
transmit, to a location management function (LMF), a positioning information update message including sounding reference signal (SRS) transmission status information, wherein the SRS transmission status information is set to an area-specific SRS activated,
receive, from the LMF, a positioning activation request message for activating a semi-persistent SRS resource set based on the SRS transmission status information, and
transmit, to the second base station, a message including information on the semi-persistent SRS resource set, as a response to the retrieve UE context request message.

9. The first base station of claim 8,
wherein the information on the semi-persistent SRS resource set includes at least one of information indicating whether to activate the semi-persistent SRS resource set, an identifier of the semi-persistent SRS resource set, or spatial relation information for the semi-persistent SRS resource set.

10. The first base station of claim 8,
wherein the instructions further cause the first base station to:
receive, from the LMF, an SRS information reservation notification including information on requested SRS transmission characteristics.

11. The first base station of claim 10,
wherein the SRS information reservation notification further includes an SRS resource list corresponding to an SRS-PosResource included in an SRS configuration information.

12. A second base station comprising:
at least one transceiver;
at least one processor communicatively coupled to the at least one transceiver; and
at least one memory, communicatively coupled to the at least one processor, storing instructions executable by the at least one processor individually or in any combination to cause the second base station to:
transmit, to a first base station, a retrieve user equipment (UE) context request message;
receive, from the first base station, a message including information on a semi-persistent sounding reference signal (SRS) resource set, as a response to the retrieve UE context request message, and
transmit, to the UE, a medium access control (MAC) control element (CE) for activating the semi-persistent SRS resource set,
wherein the information on the semi-persistent SRS resource set is based on a positioning activation request message transmitted for activating the semi-persistent SRS resource set based on SRS transmission status information, and
wherein the SRS transmission status information is set to an area-specific SRS activated.

13. The second base station of claim 12,
wherein the information on the semi-persistent SRS resource set includes at least one of information indicating whether to activate the semi-persistent SRS resource set, an identifier of the semi-persistent SRS resource set, or spatial relation information for the semi-persistent SRS resource set.

14. The second base station of claim 12,
wherein the instructions further cause the second base station to:
receive, from the LMF, an SRS information reservation notification including at least one of information on requested SRS transmission characteristics or an SRS resource list corresponding to an SRS-PosResource included in an SRS configuration information.

15. The first base station of claim 14,
wherein the SRS information reservation notification further includes an SRS resource list corresponding to an SRS-PosResource included in an SRS configuration information.
